(19) United States
(12) Patent Application Publication
(10) Pub. No.: US 2015/0033178 A1
(43) Pub. Date: Jan. 29, 2015

(54) User Interface With Pictograms for Multimodal Communication Framework

(71) Applicant: Zeta Projects Swiss GmbH, Zug (CH)

(72) Inventors: Priidu Zilmer, Tallinn (EE); Angel Sergio Palomo Pascual, Helsinki (FI); Oliver Reitalu, Tallinn (EE); Jaanus Kase, Tallinn (EE)

(21) Appl. No.: 14/311,287

(22) Filed: Jun. 21, 2014

Related U.S. Application Data
(60) Provisional application No. 61/859,228, filed on Jul. 27, 2013.

(51) Int. Cl. G06F 3/0484; G06F 3/0482; G06F 3/0481

(52) U.S. Cl. CPC G06F 3/04842; G06F 3/04817; G06F 3/0482
USPC 715/780

(57) ABSTRACT

A graphical user interface (GUI) for a device operable in a unified communication framework in which multiple users communicate using multiple modes. Conversations are kept consistent across users' devices. The GUI supports selectively replacement of phrases with corresponding pictograms, as well as selectively undoing replacements.

### RELATED APPLICATION

This application is related to and claims priority from co-owned and co-pending U.S. Provisional Patent Application No. 61/859,228, filed Jul. 27, 2013, the entire contents of which are hereby fully incorporated herein for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND OF THE INVENTION

1. Field of the Invention

This invention relates to a communication framework, and, more particularly, to a graphical user interface for a communication framework.

2. Background and Overview

Computers and computing devices, including so-called smartphones, are ubiquitous, and much of today's communication takes place via such devices. In many parts of the world, computer-based inter-party communication has superseded POTS systems.

It is desirable to provide a user interface that supports efficient and easy input across multiple types of devices. It is also desirable to provide a user interface that supports the consistent use, including input and review, of pictograms.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1A shows an overview of an exemplary communication framework in accordance with embodiments hereof;

FIG. 1B shows aspects of backend data in accordance with embodiments hereof;

FIGS. 2A-2E depict aspects of exemplary devices for use in a system in accordance with embodiments hereof;

FIG. 3A depicts an exemplary user interface (UI) according to embodiments hereof;

FIGS. 3B-3F depict aspects of input regions of exemplary UIs in a communication framework such as that shown in FIG. 1A;

FIG. 4A depicts an exemplary font table in accordance with embodiments hereof;

FIG. 4B depicts an exemplary glyph/pictogram identifier in accordance with embodiments hereof;

FIGS. 4C-4D depict exemplary messages in accordance with embodiments hereof;

FIGS. 5A-5D depict exemplary font tables in accordance with embodiments hereof;

FIGS. 6A-6C depict exemplary phrase maps in accordance with embodiments hereof;

FIG. 6D depicts aspects of a match identifier in accordance with embodiments hereof;

FIG. 7A-7D depict exemplary phrase maps using the font tables of FIGS. 5B-5D, in accordance with embodiments hereof;

FIGS. 8A-8B and 9 are flowcharts depicting exemplary operation according to embodiments hereof;

FIGS. 10A-10E, 11A-11D, 12A-12H, and 13A-13D depict examples of the system in operation; and

FIGS. 14A-14E depict aspects of computing and computer devices in accordance with embodiments hereof.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:
API means application programming interface;
GUI means graphical user interface (UI);
UI means user interface;
URI means Uniform Resource Identifier;
URL means Uniform Resource Locator;
VKB means virtual keyboard.

As used herein, the term “mechanism” refers to any device(s), process(es), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### BACKGROUND AND OVERVIEW

Overview—Structure

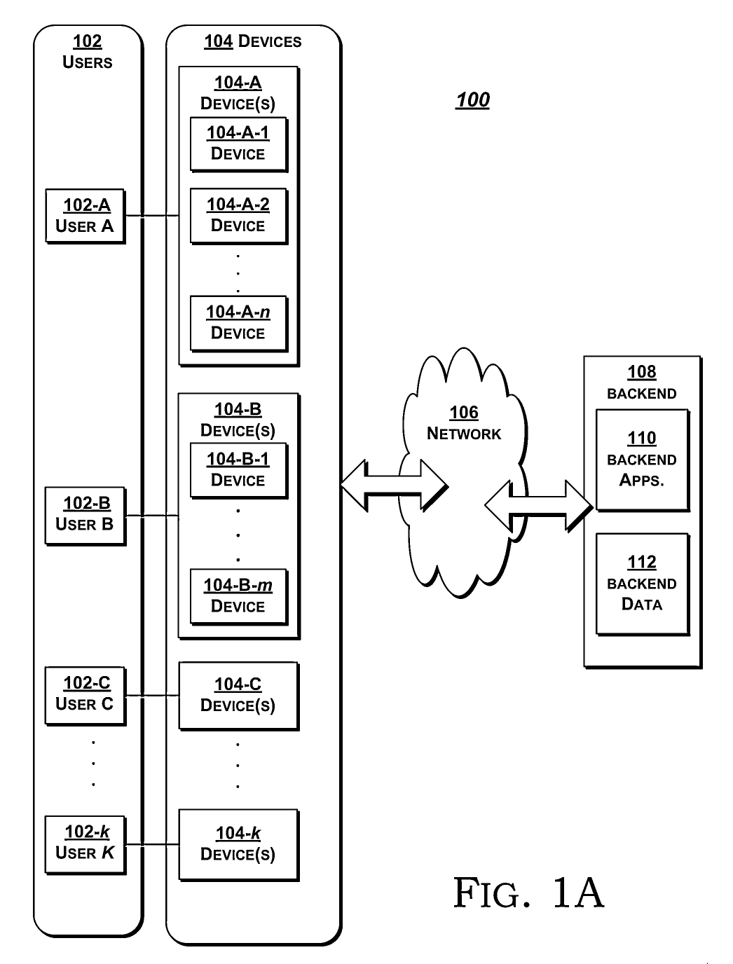

FIG. 1A shows an overview of an exemplary framework 100 for a communications system. Within the framework 100, a user 102 may have one or more devices 104 associated therewith. For example, as shown in FIG. 1A, user 102-A has device(s) 104-A (comprising devices 104-A-1, 104-A-2 . . . 104-A-n) associated therewith. Similarly, user 102-B has device(s) 104-B (comprising devices 104-B-1 . . . 104-B-m) associated therewith. The association between the user and the devices is depicted in the drawing by a line connecting a user 102 with device(s) 104 associated with that user. Although only four user/device associations are shown in the drawing, it should be appreciated that a particular system may have an arbitrary number of users, each with an arbitrary number of devices.

It should be appreciated that a user 102 may not correspond to a person or human, and that a user 102 may be any entity (e.g., a person, a corporation, a school, etc.).

Users 102 may use their associated device(s) 104 to communicate with each other within the framework 100. A user's device(s) may communicate with one or more other users' device(s) via network 106 and a backend 108, using one or more backend applications 110 and backend data 112. The backend 108 (comprising backend application(s) 110 and backend data 112) may act as a persistent store through which users 102 share data.

With reference to FIG. 1B, the backend data 112 may include UI data 114 which may include font data 116 and phrase data 118 (described in greater detail below).

As will be described in greater detail below, an interaction between a set of one or more users 102 is referred to herein as a “conversation.” In some cases a user may have a so-called “self-conversation,” in which case the user's device(s) may be considered to be communicating with each other. In the case of a self-conversation, the backend 108 may be considered to be acting as a persistent store within which a user maintains that user's self-conversation and through which that user's device(s) can view and participate in that user's self-conversation.

The devices 104 can be any kind of computing device, including mobile devices (e.g., phones, tablets, etc.), computers (e.g., desktops, laptops, etc.), and the like. Each device preferably includes at least at one display and at least some input mechanism. The display and input mechanism may be separate (as in the case, e.g., of a desktop computer and detached keyboard and mouse), or integrated (as in the case, e.g., of a tablet device such as an iPad or the like). The term “mouse” is used here to refer to any component or mechanism the may be used to position a cursor on a display and, optionally, to interact with the computer. A mouse may include a touchpad that supports various gestures. A mouse may be integrated into or separate from the other parts of the device. A device may have multiple displays and multiple input devices.

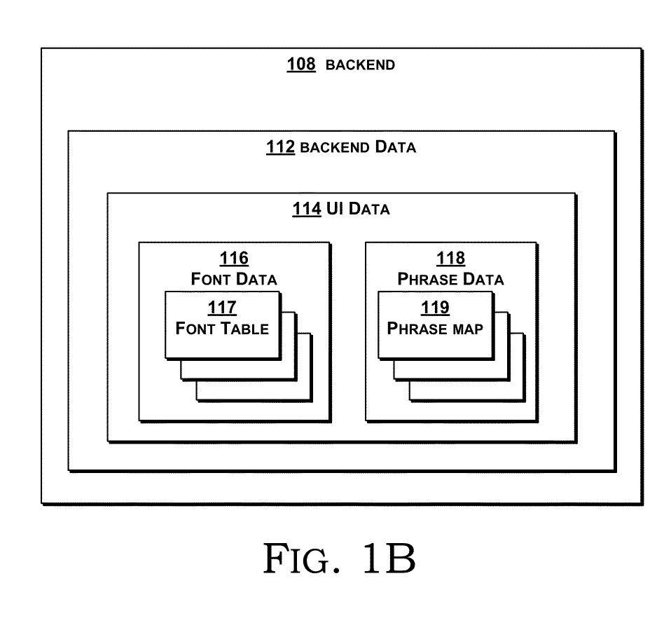

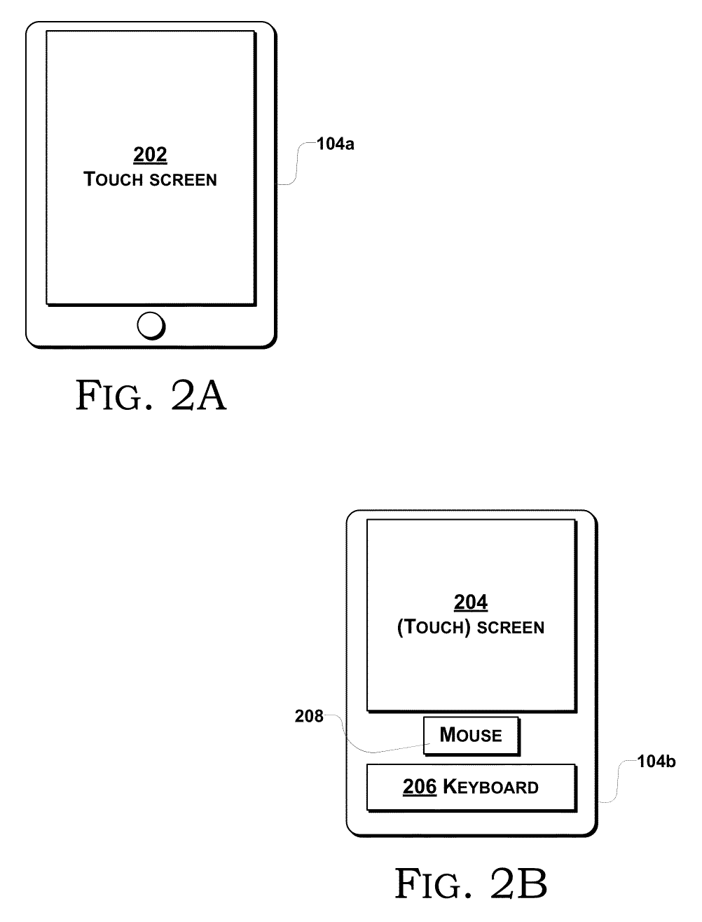

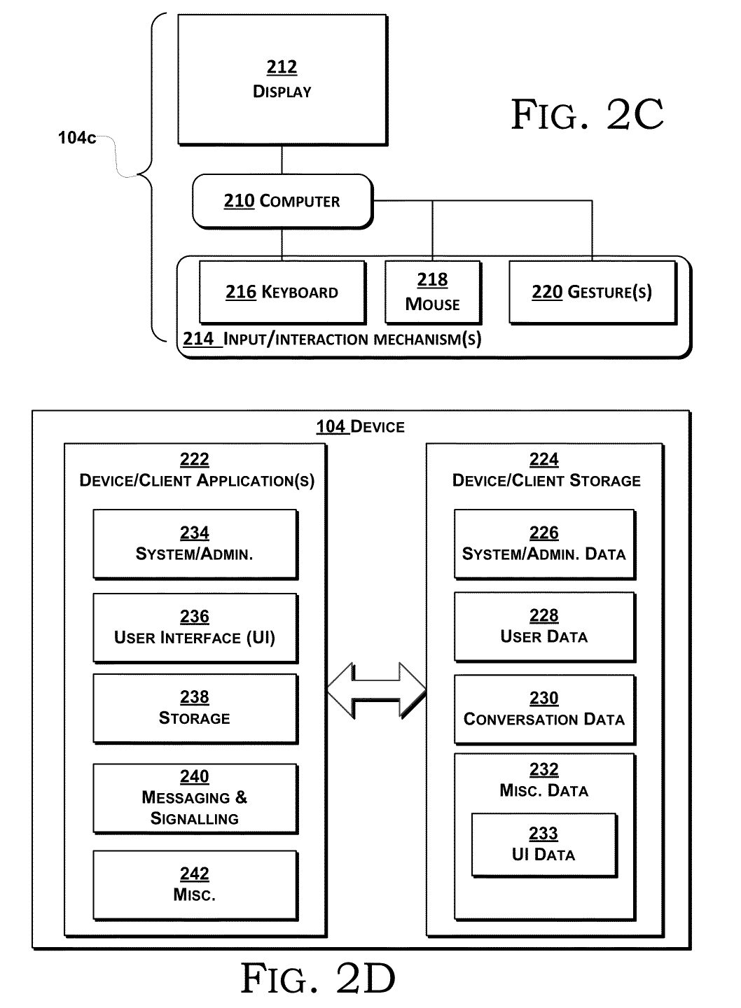

FIGS. 2A-2C show examples of devices 104a, 104b, and 104c, respectively, that may be used within the system/framework 100. These may correspond, e.g., to some of the devices 104 in FIG. 1A. Exemplary device 104a (FIG. 2A) has an integrated display and input mechanism in the form of touch screen 202. The device 104a is integrated into a single component, e.g., a smartphone, a tablet computer, or the like. The device 104a may support a software (or virtual) keyboard (VKB). Exemplary device 104b (FIG. 2B) is also integrated into a single component, but, in addition to a screen 204 (which may be a touch screen), the device includes a keyboard 206 and an integrated mouse 208 (e.g., an integrated device such as a trackball or track pad or the like that supports movement of a cursor on the screen 204). The keyboard may be a hardware keyboard (e.g., as in the case of a BlackBerry phone). The screen 204 may be a touch screen and may also support a virtual keyboard (VKB).

The exemplary device 104c (FIG. 2C) comprises multiple components, including a computer 210, a computer monitor 212, and input/interaction mechanism(s) 214, such as, e.g., a keyboard 216 and/or a mouse 218, and/or gesture recognition mechanism 220. Although the various components of device 104c are shown connected by lines in the drawing, it should be appreciated the connection between some or all of the components may be wireless. Some or all of these components may be integrated into a single physical device or appliance (e.g., a laptop computer), or they may all be separate components (e.g., a desktop computer). As another example, a device may be integrated into a television or a set-top box or the like. Thus, e.g., with reference again to FIG. 2C, the display 212 may be a television monitor and the computer 210 may be integrated fully or partially into the monitor. In this example, the input/interaction mechanisms 214 (e.g., keyboard 216 and mouse 218) may be separate components connecting to the computer 210 via wired and/or wireless communication (e.g., via Bluetooth or the like). In some cases, the input/interaction mechanisms 214 may be fully or partially integrated into a remote control device or the like. These input/interaction mechanisms 214 may use virtual keyboards generated, at least in part, by the computer 210 on the display 212.

Those of ordinary skill in the art will realize and understand, upon reading this description, that the exemplary devices 104a and 104b in FIGS. 2A-2B may be considered to be instances of the device 104c shown in FIG. 2C.

It should be appreciated that these exemplary devices are shown here to aid in this description, and are not intended to limit the scope of the system in any way. Other devices may be used and are contemplated herein.

FIG. 2D shows logical aspects of a typical device 104 (FIG. 1A), including device/client applications 222 interacting and operating with device/client storage 224. Device/client storage 224 may include system/administrative data 226, user data 228, conversation data 230, and other miscellaneous data 232. The system/administrative data 226 and/or the miscellaneous data 232 may include UI pictogram data 233 (shown in the drawing in miscellaneous data 232). The device/client application(s) 222 may include system/administrative applications 234, user interface (UI) applications 236, storage applications 238, messaging and signaling applications 240, and other miscellaneous applications 242. The categorization of data in storage 224 is made for the purposes of aiding this description, and those of ordinary skill in the art will realize and appreciate, upon reading this description, that different and/or other categorizations of the data may be used. It should also be appreciated any particular item of data may categorized in more than one way. Similarly, it should be appreciated that different and/or other categorizations of the device/client applications 222 may be used and furthermore, that any particular application may be categorized in more than one way.

As shown in FIG. 2E, the UI data 233 may comprise font data 244 and phrase data 246 (described in greater detail below). A device may obtain font data 244 from the backend 108 (e.g., from font data 116 of the backend data 112), and it may obtain phrase data 246 (e.g., from phrase data 118 of the backend data 112). A device may obtain some or all of the font data 244 and/or phrase data 246 from the backend 108 (from backend data 112) as needed. In some cases (e.g., when data are updated) the backend 108 may push UI data 114 (e.g., font data 116 and/or phrase data 118) to devices (to be used in devices as UI data 233—font data 244 and phrase data 246, respectively).

Conversations

Recall from above that the term “conversation” is used herein to refer to an ongoing interaction between a set of one or more users. In some aspects, a conversation may be considered to be a time-ordered sequence of events and associated event information or messages. The first event occurs when the conversation is started, and subsequent events are added to the conversation in time order. The time of an event in a conversation is preferably the time at which the event occurred on the backend.

Events in a conversation may be represented as or considered to be objects, and thus a conversation may be considered to be a time-ordered sequence of objects. An object (and therefore a conversation) may include or represent text, images, video, audio, files, and other assets. As used herein, an asset refers to anything in a conversation, e.g., images, videos, audio, links (e.g., URLs or URIs) and other objects of interest related to a conversation. A conversation may also include system information and messages (which may be text). In some aspects, a conversation may be considered to be a timeline with associated objects.

An object may contain the actual data of the conversation (e.g., a text message) associated with the corresponding event, or it may contain a link or reference to the actual data or a way in which the actual data may be obtained. The link may be to another location in the system 100 (e.g., in the backend 108) or it may be external. For the sake of this discussion, a conversation object that contains the actual conversation data is referred to as a direct object, and a conversation object that contains a link or reference to the data (or some other way to obtain the data) for the conversation is referred to as an indirect or reference object. A direct object contains, within the object, the information needed to render that portion of the conversation, whereas an indirect object typically requires additional access to obtain the information needed to render the corresponding portion of the conversation. Thus, using this terminology, an object may be a direct object or an indirect object.

As used herein, the term “render” (or “rendering”) with respect to data refers to presenting those data in some manner, preferably appropriate for the data. For example, a device may render text data (data representing text) as text on a screen of the device, whereas the device may render image data (data representing an image) as an image on a screen of the display, and the device may render audio data (data representing an audio signal) as sound played through a speaker of the device (or through a speaker or driver somehow connected to the device), and a device may render video data (data representing video content) as video images on a screen of the device (or somehow connected to the device). The list of examples is not intended to limit the types of data that devices in the system can render, and the system is not limited by the manner in which content is rendered.

It should be appreciated that a particular implementation may use only direct objects, only indirect objects, or a combination thereof. It should also be appreciated that any particular conversation may comprise direct objects, indirect objects, or any combination thereof. The determination of which conversation data are treated as direct objects and which as indirect objects may be made, e.g., based on the size or kind of the data and on other factors affecting efficiency of transmission, storage, and/or access. For example, certain types of data may be treated as indirect objects because they are typically large (e.g., video or images) and/or because they require special rendering or delivery techniques (e.g., streaming).

As used herein, the term “message” refers to an object or its (direct or indirect) contents. Thus, for a direct object that includes text, the message is the text in that direct object, whereas for an indirect object that refers to an asset, the message is the asset referred to by the indirect object.

In a presently preferred implementation, conversations may use a combination of direct and indirect objects, where the direct objects are used for text messages (including system messages, if applicable) and the indirect objects are used for all other assets. In some cases, text messages may be indirect objects, depending on their size (that is, an asset may also include or comprise a text message). It should be appreciated that even though an asset may be referenced via an indirect object, that asset is considered to be contained in a conversation and may be rendered (e.g., displayed) as part of (or apart from) a conversation.

Each device should be able to render each asset in a conversation in some manner.

It should be appreciated that the assets in a conversation (i.e., the assets referenced by indirect objects in the conversation) may be of different types (e.g., audio, pictures, video, files, etc.), and that the assets may not all be of the same size, or stored in the same place or in the same way.

As used herein, a user participating in a conversation is said to be conversing or engaging in that conversation. The term “converse” or “conversing” may include, without any limitation, adding any kind of content or object to a conversation, and removing or modifying any kind of content or object within a conversation. It should be appreciated that the terms “converse” and “conversing” include active and passive participation (e.g., viewing or reading a conversation). It should further be appreciated that the system is not limited by the type of objects in a conversation or by the manner in which such objects are included in or rendered within a conversation.

The User Interface (UI)

Clients (users' devices 104) interact with each other and the system 100 via the backend 108. These interactions generally take place, at least in part, using a user interface (UI) application 236 (FIG. 2D) running on each client (device 104, FIG. 1A).

A user of a device 104 uses the UI on that device to interact with other applications on the device. In a general case, a user's interaction with the UI causes the UI to provide information (e.g., instructions, commands, or any kind of input) to other applications. And other applications' interactions with the UI cause the UI to present information to the user (e.g., on the screen of the device 104, via an audio system associated with the device, etc.).

A UI is implemented, at least in part, on a device 104 and preferably uses the device's display(s) and input/interaction mechanism(s) (e.g., 214, FIG. 2C). Use of a UI may require selection of items, navigation between views, and input of information. It should be appreciated that different devices may support different techniques for presentation of and user interaction with the UI. For example, a device with an integrated touch screen (e.g., device 104a as shown in FIG. 2A) may display UI information on the touch screen 202, and accept user input (for navigation, selection, input, etc.) using the touch screen (e.g., with a software/virtual keyboard—VKB—for some types of input). A device with an integrated screen, keyboard, and mouse (e.g., device 104b as shown in FIG. 2B) may display UI information on the screen 204, and accept user input using the hardware keyboard 206 and hardware mouse 208. If the screen/display 204 is also a touch screen display, then user interactions with the UI may use the screen instead of or in addition to the keyboard 206 and mouse 208. A device with separate components (e.g., some instances of device 104c of FIG. 2C) may display UI information on the display 212 and accept user input to the UI using input/interaction mechanism(s) 214 (e.g., the keyboard 216 and/or mouse 218 and/or gesture mechanism 220).

UI Interactions

A UI presents information to a user, preferably by rendering the information in the form of text and/or graphics (including drawings, pictures, icons, photographs, etc.) on the display(s) of the user's device(s). The UI 236 preferably includes or has access to rendering mechanism(s) appropriate to the various kinds of data it may be required to render. For example, the UI 236 may include or have access to one or more mechanisms for text rendering, image rendering, sound rendering, etc. These rendering mechanisms may be included in the device/client application(s) 222.

The user may interact with the UI by variously selecting regions of the UI (e.g., corresponding to certain desired choices or functionality), by inputting information via the UI (e.g., entering text, pictures, etc.), and performing acts (e.g., with the mouse or keyboard) to affect movement within the UI (e.g., navigation within and among different views offered by the UI).

The UI application(s) 236 (FIG. 2D) preferably determine (or know) the type and capability of the device on which it is running, and the UI may vary its presentation of views depending on the device. For example, the UI presented on a touch screen display on a smartphone may have the same functionality as the UI presented on the display of general-purpose desktop or laptop computer, but the navigation choices and other information may be presented differently.

It should be appreciated that, depending on the device, the UI 236 may not actually display information corresponding to navigation, and may rely on unmarked parts of the screen and/or gestures to provide navigation support. For example, different areas of a screen may be allocated for various functions (e.g., bottom for input, top for search, etc.), and the UI may not actually display information about these regions or their potential functionality. It should be appreciated that the functionality associated with a particular area or portion of a display screen may change, e.g., depending on the state of the UI.

As has been explained, and as will be apparent to those of ordinary skill in the art, upon reading this description, the manner in which UI interactions take place will depend on the type of device and interface mechanisms it provides.

As used herein, in the context of a UI, the term “select” (or “selecting”) refers to the act of a user selecting an item or region of a UI view displayed on a display/screen of the user's device. The user may use whatever mechanism(s) the device provides to position the cursor (which may or may not be visible) appropriately and to make a desired selection. For example, a touch screen 202 on device 104a may be used for both positioning and selection, whereas device 104b may require the mouse 208 (and/or keyboard 206) to position a cursor on the display 204 and then to select an item or region on that display. In the case of a touch screen display, selection may be made by tapping the display in the appropriate region. In the case of a device such as 104c, selection may be made using a mouse click or the like.

Touch Screen Interfaces and Gestures

Touch-screen devices (e.g., an iPad, iPhone, etc.) may recognize and support various kinds of touch interactions, including gestures, such as touching, pinching, tapping, and swiping. These gestures may be used to move within and among views of a UI.

Views & Input Regions

In a presently preferred implementation the UI (implemented, e.g., using UI interface application(s) 236 on device 104) comprises a number of views. These views may be considered to correspond to various states in which the device/client application(s) 222 may be.

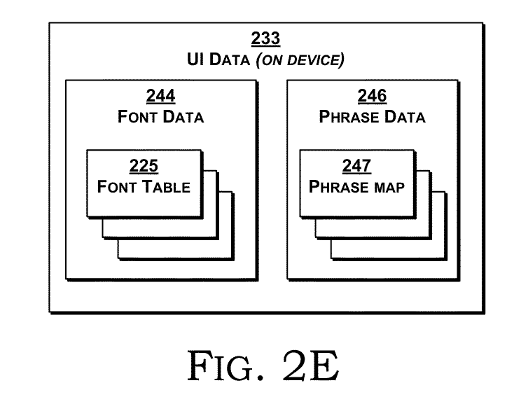

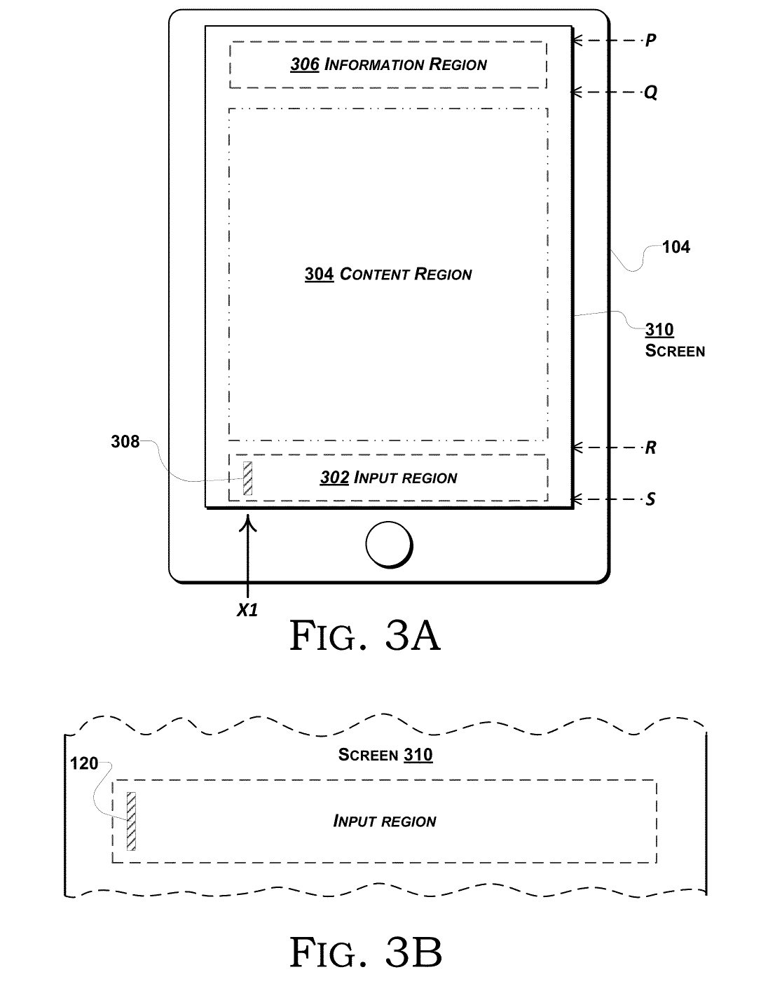

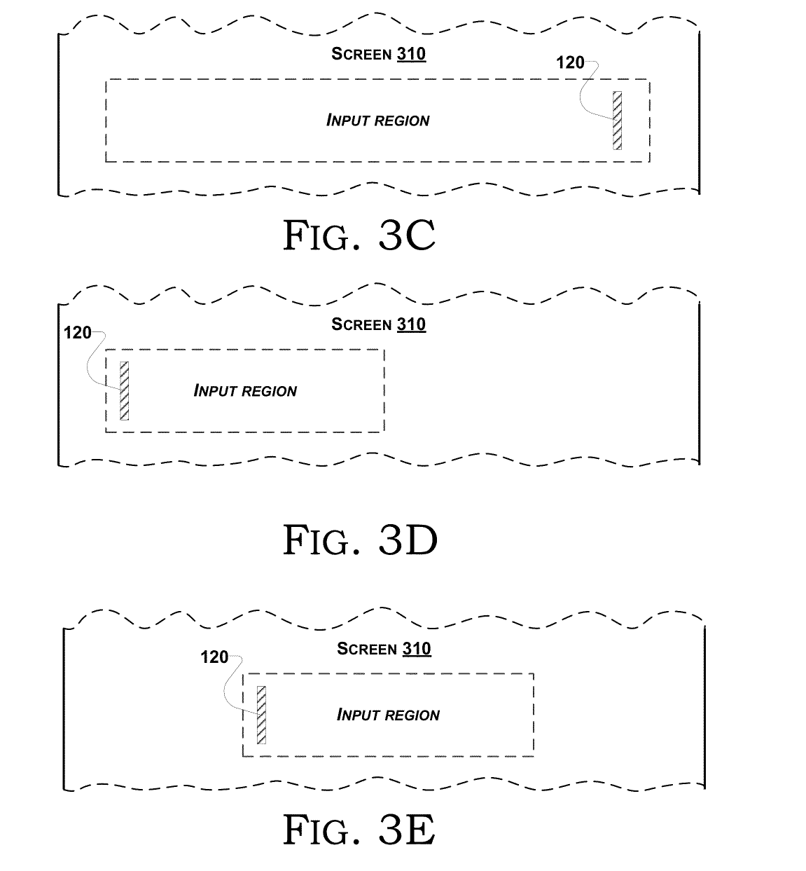

FIG. 3A shows an exemplary view 300 of a UI supported by user interface (UI) 236 of a device 104. The view 300 may be displayed on the display mechanism of the device (e.g., touch screen 202 of exemplary device 104a in FIG. 2A, screen 204 of exemplary device 104b in FIG. 2B, display 212 of exemplary device 104c in FIG. 2C, etc.). In FIG. 3A the view is shown on the screen 310 of device 104. In order to simplify the drawings, and for the sake of explanation, in subsequent drawings, the display mechanism (e.g., screen) and other features of the underlying device on which the view is displayed may not be shown.

With reference to the drawing in FIG. 3A, an exemplary view 300 comprises an input region 302, a content region 304, and an information region 306. Although shown in the drawing at the bottom of the screen, the input region 302 may be located anywhere on the screen, and its location may vary during operation of the system. For example, in a conversation view, the input region may be located at the bottom of the screen. However, during a conversation, the location of the input region may change.

Although only one input region is shown, it should be appreciated that that multiple input regions, possibly having different functionality, may be provided on a particular view. For example, a view provided by the GUI may have a search input region and another content input region.

The information region 306, if present, may provide, e.g., a caption or subject for the content (e.g., when the view 300 is a conversation view, the information region 306 may list the conversation participants). In some cases the information region 306 may be omitted. In the drawings the various regions are shown with dashed lines indicating their positions on the display. It should be appreciated that in preferred implementations, the actual regions are not outlined or highlighted on the display.

In preferred implementations (as shown, e.g., in FIGS. 3A-3B) a boundary of the input region 302 is indicated by a cursor 308 (e.g., a vertical bar rendered on the left side of the input region 302, such as at horizontal position X1 in FIG. 3A). For input of languages that are written from right to left, the cursor 308 may default to a position on the right side of the input region 302, as shown in FIG. 3C.

In the case, e.g., of a conversation view, the input region 302 may use an area on the bottom of the screen (between vertical positions R and S in FIG. 3A), the conversation region 304 uses an area of the screen between vertical positions Q and S, and the information region 306 (if present) uses an on the top of the screen (between vertical positions P and Q in FIG. 3B). In other views (or other states of the conversation view), the input region may be located elsewhere on the screen.

In other embodiments, the positions of the input region 302 and/or information region 306 may be in alternate positions (e.g., both at the top, both at the bottom, or in exchanged positions). Those of ordinary skill in the art will appreciate and understand, upon reading this description, that the input region may span a different and/or much smaller portion of the screen 310 than shown in FIGS. 3A-3C, and need not be centered on the screen. For example, as shown in FIGS. 3D-3F respectively, the input region may be located towards the left, middle, or right of the screen 310. In general, it should be appreciated that the drawings present only example locations and sizes of the cursor and input region, and that a particular implementation may support multiple input region shapes, locations and/or sizes and multiple cursor shapes, locations and/or sizes.

Size and Scale

Although some regions are shown in the drawings as having gaps between them, it should be appreciated that in an actual implementation, there may not be gaps between some or all regions, and some or all of the regions may abut adjacent regions. It should also be appreciated that the regions in the drawings are not drawn to scale and that the relative sizes of the regions in the drawings are exemplary and not limiting.

Active UI Regions

As used herein, in the context of the UI 236, a region on a screen is considered “active” if that region is selectable within the UI to cause some action to take place, either within the UI or by other parts of the system. Thus, e.g., and without limitation, a region is active if tapping that region causes the UI to make something happen. It should be appreciated that an active region need not be marked nor have its boundaries marked. In addition, the input region need not be marked nor have its boundaries marked on the screen.

In the drawings the various active text options are show with dotted lines around them. These lines are shown for the purpose of this explanation. It should be appreciated that in an actual implementation the text regions may or may not be outlined or highlighted in some way. However, when there are multiple text options exposed, it is preferable to distinguish them in some way (e.g., by outlining or shading them).

Fonts & Glyphs

Recall from above that a conversation comprises a time-ordered sequence of objects which may include or represent text messages or objects. The UI supported by UI 236 of a device 104 allows a user to input text as part of a conversation. The UI 236 preferably supports a default input font that is used to display text objects on the screen(s) or display(s) of the device 104.

As used herein, a “font” refers to any collection of glyphs, no matter how stored or represented. In some aspects, a “font” can be considered to refer to a collection of glyphs, where a “glyph” refers to a character or symbol or pictograph. A “glyph” may be static or dynamic (e.g., animated). A font may be a physical font or a logical font.

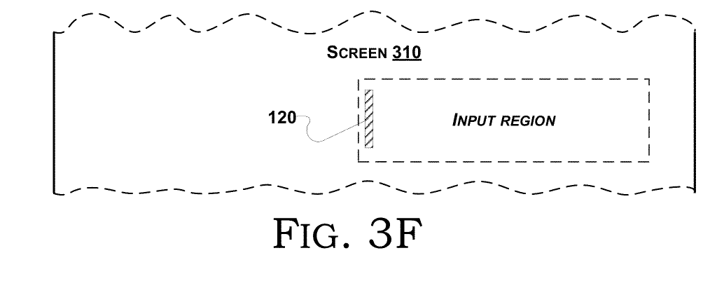

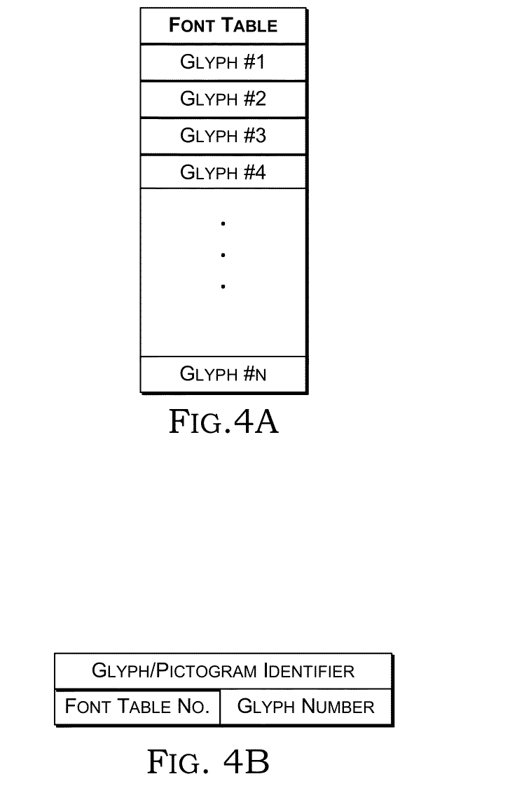

Within a system/framework 100, fonts (or information required to represent and render the glyphs in a font) may be stored in font tables. An exemplary font table is shown in FIG. 4A, in which the font table stores and provides information about a number of glyphs (in the example there are n glyphs).

As a particular system/framework 100 may support the input and rendering of multiple fonts, the system/framework typically provides multiple font tables. For the purposes of this description is assumed that a particular font within the system may be uniquely identified by a font number. Each font table is thus preferably uniquely identifiable within the system (e.g., by a font number or the like). If a font has more than one font table, it is assumed, for the purposes of this description, that each font table may be uniquely identified within the system by a font table number. Thus, as shown in FIG. 4B, any particular glyph may be identified by a glyph or pictogram identifier comprising a <font table number, glyph number> pair. Those of ordinary skill in the art will appreciate and understand that other information may be used to select a particular glyph (e.g., a <font number, glyph number> pair).

The font data 116 in the backend data 112 (FIG. 1B) may comprise one or more fonts (e.g., font tables 117). The font data 244 in the UI data 233 on a device may also comprise one or more fonts (e.g., font tables 225). It should be appreciated that not every device needs or has all of the font data that is on the backend 108. For example, a device may not need (or have) fonts for all languages. A particular device may obtain needed font data 244 from the backend data 112 on demand, or such data may be pushed to the device from the backend.

Although the description refers to font tables, those of ordinary skill in the art will realize and appreciate, upon reading this description, that font data may include other information about and/or properties associated with each font (e.g., information used to render the fonts such as font size, font typeface, graphics, text, icons or resolution, etc.).

As shown in FIG. 4C, a text message (e.g., in a conversation) comprises a sequence of characters or glyphs C1, C2, C3 . . . Ck, where each character comprises a glyph/pictogram identifier (e.g., a <font table number, glyph number> pair, as shown in FIG. 4B).

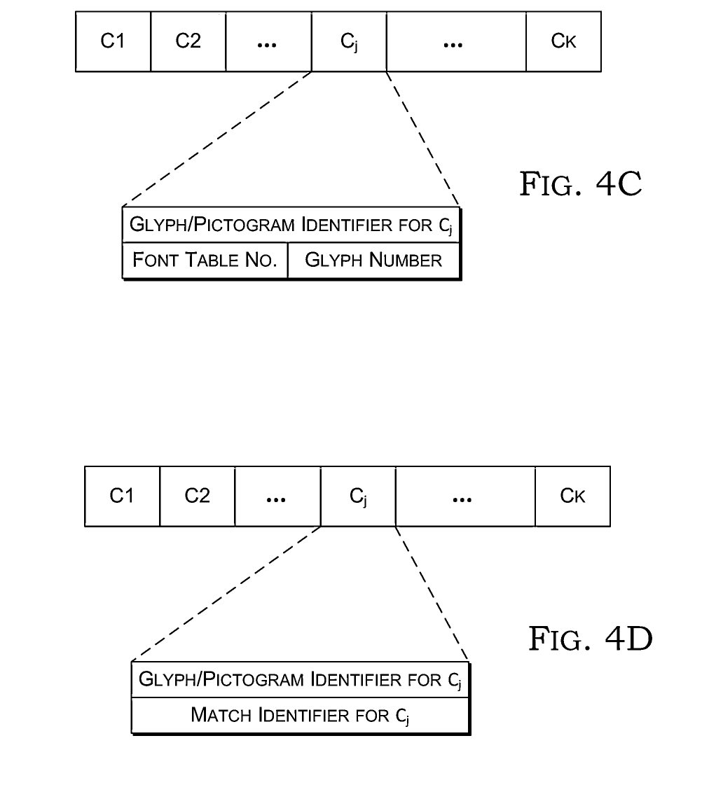

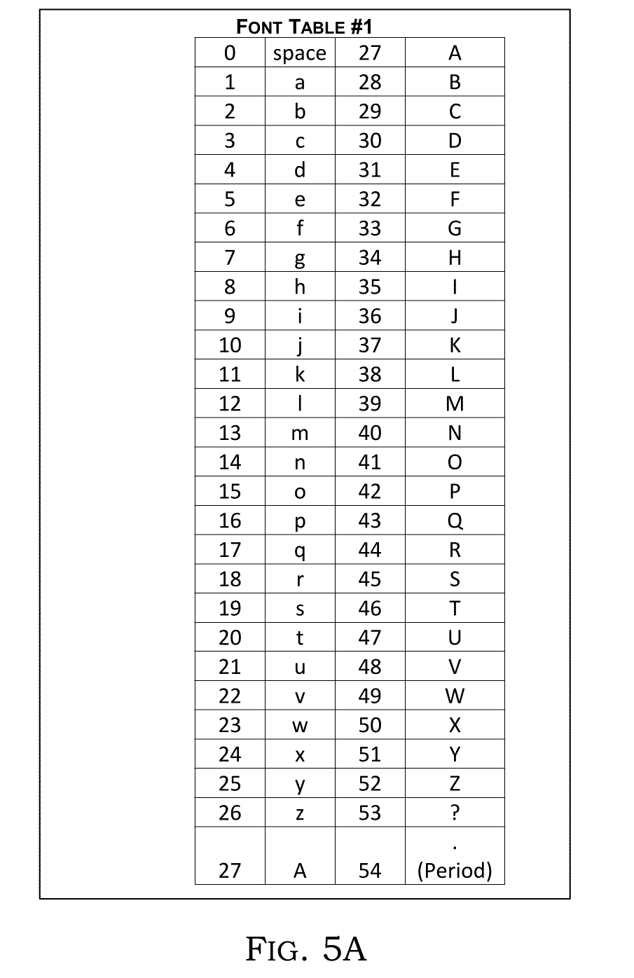

FIG. 5A shows an exemplary font table consisting of fifty four (54) characters of the Roman/Latin alphabet. In this example font table, glyph number 0 (zero) is a space, glyph number 1 is the letter “a”, glyph number 2 is the letter “b”, and so on. For the purposes of this description, the example font table in FIG. 5A is considered Font Table #1.

As will be appreciated by those of ordinary skill in the art, the glyphs in a font table need not be (or need not all be) alphabetic letters or characters. FIGS. 5B-5D show three exemplary font tables (numbers 17, 231, and 632, respectively) comprising various non-alphabetic glyphs. For the sake of this description only some glyphs are shown for each of these example fonts. It should also be appreciated that the glyphs used herein are for descriptive purposes only. Those of ordinary skill in the art will appreciate and understand that a particular font table may include more glyphs than shown, and may include alphabetic and non-alphabetic glyphs. However, there is no requirement that any particular font table have glyphs corresponding to each glyph number. It should also be appreciated that the font numbers and font table numbers used herein are for descriptive purposes only.

A particular glyph may appear in more than one font table. E.g., as shown in FIGS. 5B-5C, the glyph number 7 is the same in both tables 17 and 231 (i.e., glyphs <17, 7> and <231, 7> are the same). However, even when a glyph appears in more than one font table, that glyph need not have the same glyph number in both tables. For example, as shown in FIGS. 5C-5D, glyph <231,33> (i.e., glyph number 33 in font table no. 231, a pictogram of a taxi) is the same as glyph <632, 8> (i.e., glyph number 8 in font table no. 632). Furthermore, a particular glyph may appear more than once in the same font table (not shown in the examples in the drawings).

It should be appreciated that the font tables shown in FIGS. 5A-5D may be stored as font tables 117 in the backend data 112. It should further be appreciated that these font tables may also be stored on particular devices as font tables 225 in font data 224. As noted, a device 104 may obtain font data 224 in advance and/or as needed from the backend 108. In some systems, even when devices specifically request font data from the backend, the backend may still provide font data to devices when those data are updated. The backend may maintain a list of which devices have which font data, so that updates may be preemptively pushed to the devices.

Phrase Table(s)

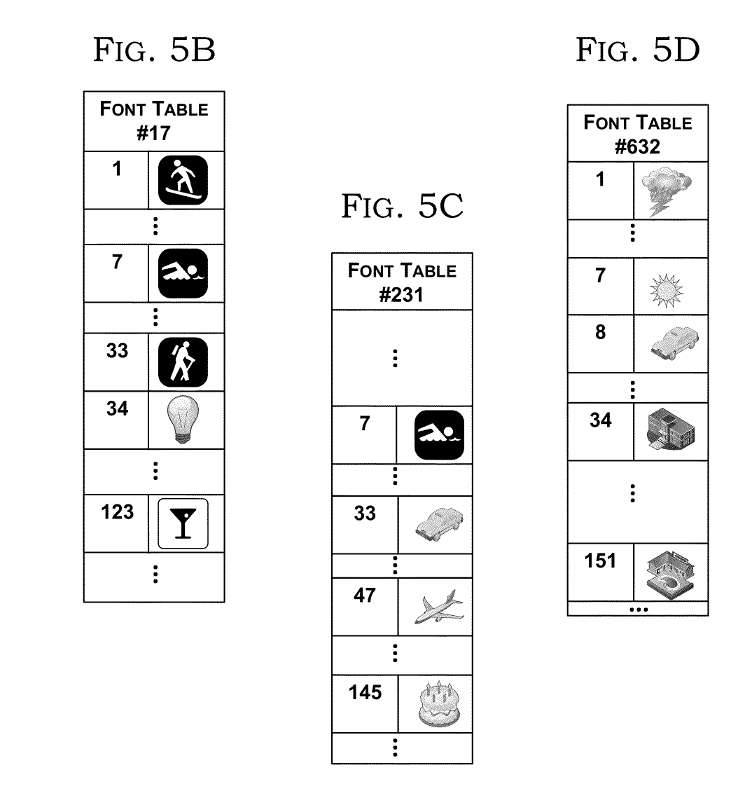

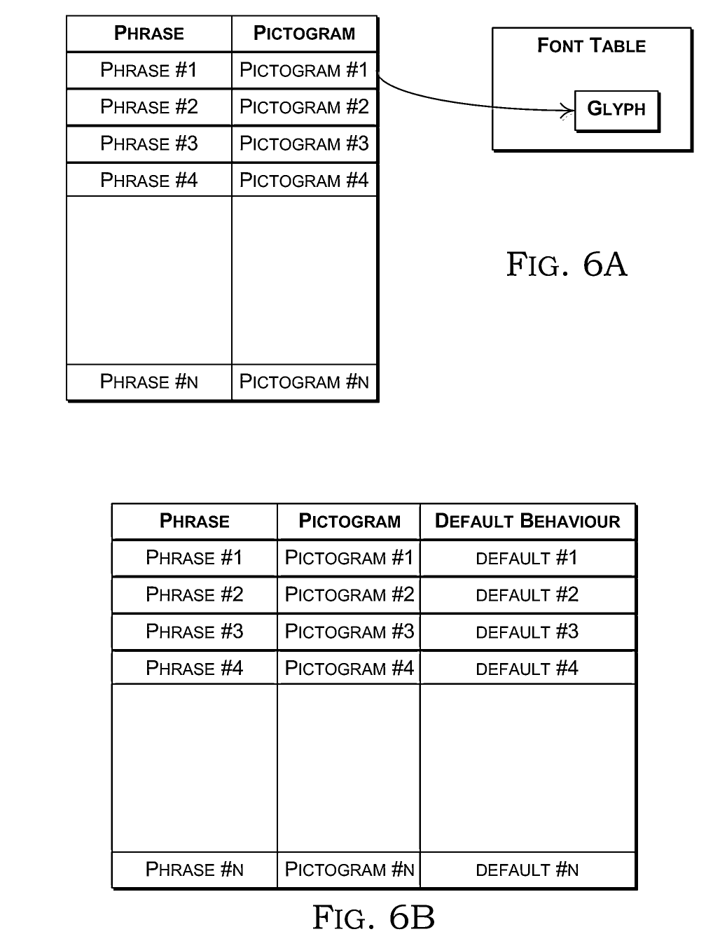

The framework 100 preferably provides one or more tables (referred to here as “phrase tables”) that essentially provide a mapping from phrases (e.g., textual phrases) to pictograms. An exemplary phrase table 600 is shown in FIG. 6A, where each of n phrases maps to a corresponding pictogram (preferably identified by a glyph or pictogram identifier, e.g., a <font table, glyph number> pair. Thus, as shown in FIG. 6A, phrase #1 maps to pictogram #1, phrase #2 maps to pictogram #2, and so on.

Preferably all of the phrases in a phrase table are unique. However, it should be appreciated multiple phrases (in one or more phrase tables) may map to the same pictogram.

Although shown here in table form, a particular implementation may store the phrase map(s) in other forms, e.g., optimized to perform quick and efficient matching with input text.

The phrase data 118 in the backend data 112 (FIG. 1B) may comprise one or more phrase maps 119, e.g., phrase tables. The phrase data 246 in the UI data 233 on a device may also comprise one or more phrase maps 247 (e.g., phrase tables). It should be appreciated that not every device needs or has all of the phrase data that is on the backend 108. For example, a device may not need (or have) phrase tables for all languages. A particular device may obtain needed phrase data 246 from the backend 108 (from backend data 112) on demand, or such data may be pushed to the device from the backend.

As noted, a particular system 100 or implementation may provide multiple phrase tables. For example, a system or implementation may provide different phrase tables for different languages. In this manner, devices need not obtain or store phrase tables for languages that their users are not using. Since the backend 108 stores and maintains all potentially needed phrase tables (as phrase maps 119 in phrase data 118, FIG. 1B), a device that needs particular phrase data may obtain the needed data from the backend. In some cases, the backend 108 may determine that a particular device needs certain phrase data, in which cases the backend may push the needed phrase data to that particular device. For example, if a device receives a message using a language not previously used on that device, the backend 108 may, of its own accord, push potentially needed UI data 114 (e.g., font data 116 and/or phrase data 118) to that device. Using such an approach, the device will have the data it needs to render the message without having to request the data.

Default Behavior

In some embodiments a user must affirmatively decide whether to replace the matching phrase with the corresponding pictogram. In some embodiments, the phrase map may include a default behavior for each <phrase, pictogram> pair. An exemplary phrase map 602 is shown in FIG. 6B, where (as with the phrase table 600 in FIG. 6A) each of n phrases maps to a corresponding pictogram (preferably identified by a glyph or pictogram identifier, e.g., a <font table, glyph number> pair. In the phrase map 602 a default behavior is provided for each phrase. In some embodiments the default behavior may be either “automatically replace” or “selectively replace.” Those of ordinary skill in the art will appreciate and understand, upon reading this description, that different and/or other default behaviors may be used. In addition, although the phrases “automatically replace” and “selectively replace” are used for this description, those of ordinary skill in the art that, in a particular implementation, these options may be represented by a single bit.

In general, the default behavior may be controlled by a rule or set of rules that may use information such as shown in the phrase map 602 as well as information determined from user preferences and other system preferences. For example, the system may have a rule that automatic replacement does not take place for the first phrase of a sentence. In this example, the system is using default behavior associated with a phrase along with a phrase-independent rule (“no automatic replacement at the start of the sentence”).

When the default behavior is “selectively replace” then the UI 236 replaces the phrase with the corresponding pictogram based on an affirmative selection by the user. On the other hand, when the default behavior is “automatically replace”, then the UI 236 may replace the matching phrase with the corresponding pictogram without any action by the user. As will be explained below, in some embodiments the user may undo any default substitution.

In some embodiments the system may learn a user's substitution preferences, and may modify the default behavior for a particular mapping for that user. For example, if the phrase map maps the word “sunny” to a pictogram of the sun, and if the default behavior for that mapping is “selectively replace,” and if a particular user always (or mostly) selects the replacement for that phrase, the UI 236 may modify the default behavior for that mapping for that user to “automatically replace”. While modifications to the default behavior for a mapping are user-specific, the system may choose to modify the default behavior for all users if it determines that most or many users use it behavior distinct from the default.

### Examples

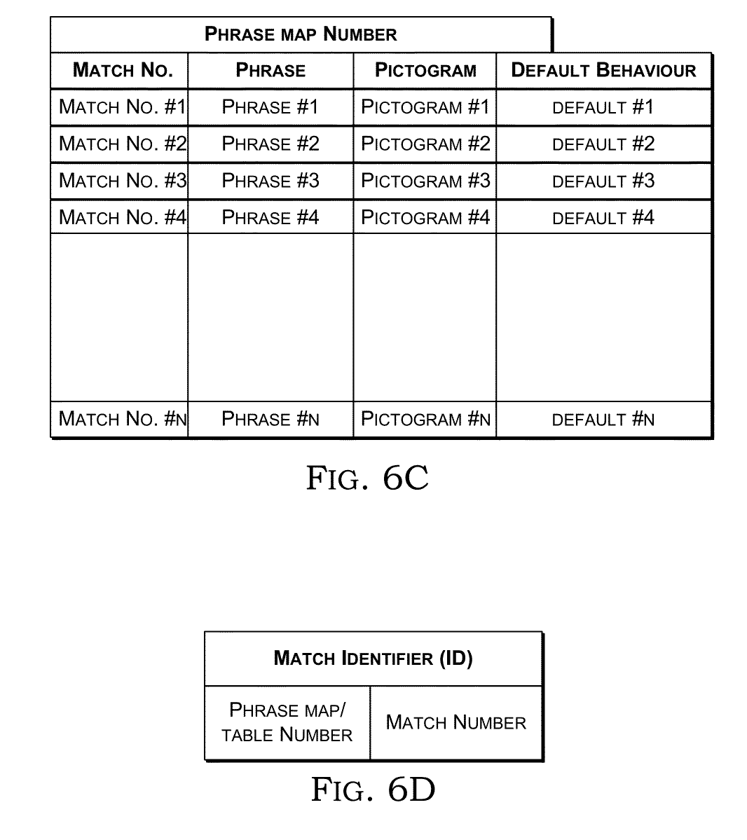

FIG. 7A shows an example phrase table 700 using the font tables of FIGS. 5B-5D. As shown in FIG. 7A, the phrase “swim” maps to the glyph <17, 7> (i.e., glyph number 7 in font table 17), the phrase “swimming” maps to the glyph <231, 7> (i.e., glyph number 231 in font table 7), and so on.

FIG. 7B shows another example phrase table 700 using the font tables of FIGS. 5B-5D. The example phrase map 700 in FIG. 7B includes information about the default behavior for each mapping. In this example, the phrases “swim” and “sunny” are automatically replaced.

FIG. 7C is a German version of the mapping provided by the English language phrase map 700 of FIGS. 7A-7B, and FIG. 7D is an Estonian version of the map provided by the English language phrase map 700 of FIGS. 7A-7B. Note that the phrases in the phrase tables 703 and 704 use the same font tables as the mapping 700.

It should be appreciated that the phrase tables shown in FIGS. 7A-7B may be stored as phrase maps 119 in the backend data 112. It should further be appreciated that these phrase tables may also be stored on particular devices as phrase maps 247 in phrase data 246. As noted, a device 104 may obtain phrase data 118 in advance and/or as needed from the backend 108. In some systems, as with font data, even when devices specifically request phrase data from the backend, the backend may still provide phrase data to devices when those data are updated. The backend may maintain a list of which devices have which phrase data, so that updates may be preemptively pushed to the devices.

Those of ordinary skill in the art will appreciate and understand, upon reading this description, that the various (multiple) phrase maps (e.g., phrase tables) may be combined. However, to the extent that certain phrase maps are unlikely to be used on the same system (e.g., because they are in different languages), it is likely to be more efficient to provide multiple and separate phrase maps. Thus, for example, the system may provide multiple distinct phrase maps for each of multiple languages. The system may use information obtained from the device (e.g., information provided by the user regarding a default language and/or information determined based on the text being input by the user the device) to determine what language(s) the device needs to support. Phrase data may thus be obtained by the device (based on a device request and/or preemptively pushed from the backend) for the language(s) that the device needs to support.

Operation of the System

In operation, the UI 236 uses one or more phrase tables and font tables (preferably stored on the device 104 as UI data 233, as shown in FIGS. 2D-2E) to map input phrases to corresponding glyphs. As described below, in preferred embodiments the mapping of input phrases to glyphs is selective and under user control. As noted, the device 104 may request needed UI data 233 and/or such data may be preemptively provided (e.g., pushed) to the device by the backend 108.

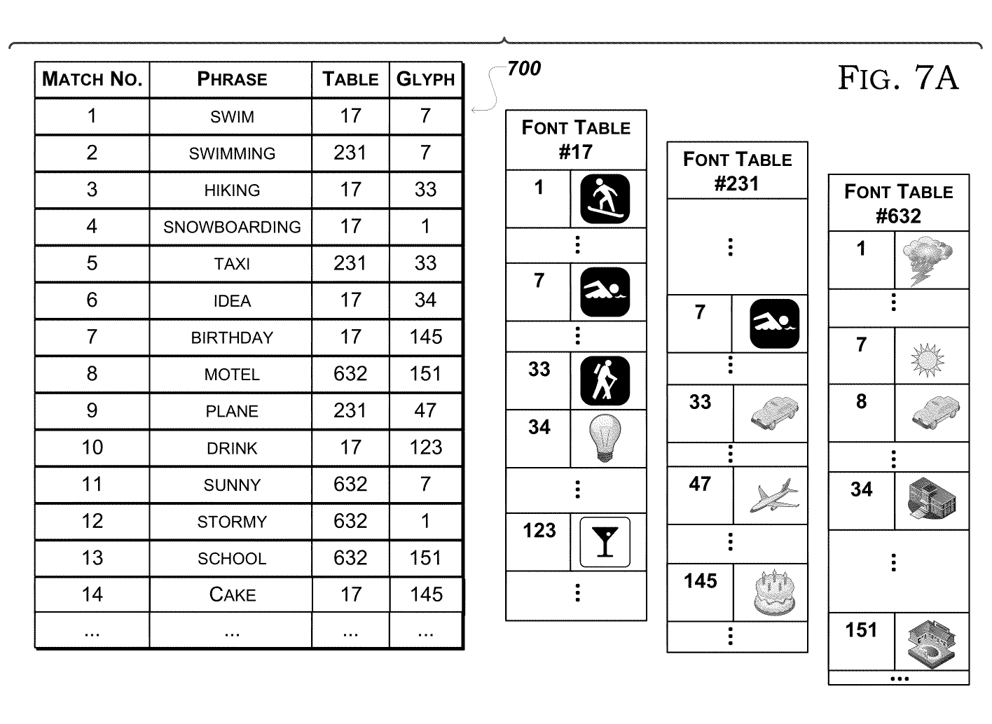

With reference to the flowchart in FIG. 8A, when a user inputs a text message (via the UI 236), an input buffer (e.g., as shown in FIG. 4C) is used. When the user begins inputting a “match string” is set to null (the empty string “ ”, at S800). The UI 236 gets the next input character (at S801) and displays that character on the input screen (at S802).

As discussed further below, the match string may selectively be reset to null (at S803).

The input character is then selectively added to the match string (at S804). In preferred embodiments phrases in the phrase table are single characters or words without spaces or certain punctuation. Accordingly, any such punctuation or spaces in the input will not be used for lookup and will therefore not be added to match string.

The match string is then looked up in the phrase table(s) (phrase map(s) 247 on the device) (at S805) to determine whether the match string matches any phrase in the table(s). If no match is found (at S805) then processing continues with the next input character (at S801).

On the other hand, if a matching phrase is found in a phrase table/mapping 247 on the device (at S805), then the UI 236 presents the corresponding matching pictogram on the display screen of the device (at S807). It should be appreciated that in order to present the matching pictogram, the UI 236 needs access to the appropriate font table. Preferably this font table is already stored as a font table 225 in the UI data 233 on the device. However, if the font table is not already on the device, the device may try to obtain the needed font table from the backend data 112. In order to avoid delays associated with obtaining data from the backend, each device is preferably pre-populated with font table(s) 225 associated with any phrase data 246 (e.g., phase mappings 247) already stored on the device.

The matching pictogram (i.e., the pictogram to which the match string mapped via the phrase maps) may be presented in any location, e.g., above the matching phrase, next to the matching phrase, etc. In a presently preferred implementation the matching pictogram is presented on the other side of the input cursor from the text being input. That is, when the input language is left-to-right, the text will be on the left of the cursor and the matching pictogram will be presented by the UI on the right of the cursor. For right-to-left input languages the display is preferably the opposite that of left-to-right input languages.

With the matching pictogram displayed (at S806), the UI 236 determines (at S807) whether or not the matching phrase should be replaced by the corresponding pictogram. The phrase may be replaced, e.g., based on one or more of: default behavior associated with that <phrase, pictogram> pair (if such default behavior is provided); system rules, user action; user preferences; and user's prior actions.

For example, as shown in the flowchart segment in FIG. 8B, the system may determine (at S807) whether or not to place the phrase with the corresponding pictogram based on rules and/or default behavior settings (at S810). If the rules or default behavior settings (alone or in combination) require replacement, then the phrase is immediately replaced with the corresponding pictogram (at S808, FIG. 8A). In these cases, even though pictogram was presented on the input screen (at S806) (e.g., to the right of the cursor) it is immediately used to replace the corresponding phrase.

If the rules or default behavior settings do not require immediate replacement (as determined at S810) (or if no default behavior settings are provided), the system determines (at S811) whether the user chooses to replace the phrase with the corresponding pictogram. If the system determines that the user wishes to replace the phrase with the corresponding pictogram, then the phrase is immediately replaced with the corresponding pictogram (at S808, FIG. 8A), otherwise processing continues with the next input character (at S801, FIG. 8A). For example, the user may select the pictogram (e.g., by tapping or clicking on it). When the UI determines that the user has selected the matching pictogram (at S811) then the UI replaces the matching phrase with the pictogram on the input screen (at S808), the UI then sets the matching string to null (at S809) and the system continues to obtain input (at S801).

It should be appreciated that it may be necessary to reset the “match string” to null after some input has been received without a match. In presently preferred embodiments each phrase is a single character or word, so that the “match string” may be reset to null each time the end of a word is detected (e.g., by the input of a space or punctuation character). This selective reset may take place between steps S801 and S804 (e.g., as step S803).

Reverse Lookup

Recall, as can be seen from the example in FIG. 7A, multiple phrases may map to the same pictogram (e.g., both “birthday” and “cake” map to the pictogram at <17, 145>). Accordingly, in some embodiments and in some cases the UI may display multiple phrases for a selected pictogram. Recall too, as shown in FIG. 4C, that a text message may comprise a sequence of characters or glyphs C1, C2, C3 . . . Ck, where each character comprises a glyph/pictogram identifier. In order to support efficient and accurate reverse lookup (reverse mapping) from pictograms to phrases, in some embodiments, for example as shown in FIG. 6C, the phrase map may include a match identifier that is unique within the system for each <phrase, pictogram> pair.

Thus, in some embodiments, each entry in the phrase table may have a unique identifier or number, and this number may be included in the message stream to facilitate reverse lookup of the phrase table from a given message string.

In preferred embodiments, each phrase map 119 (and therefore each phrase map 247 on each device) in the system (e.g., each phrase table) has a unique number (e.g., Phrase Mapping Number in FIG. 6C). Furthermore, within each phrase map, each <phrase, pictogram> pair has a unique match number. Thus each match within the system may be uniquely identified by a match identifier comprising the phrase map/table number of the phrase table with that match occurred and the match number of that match the table.

With reference to the example in FIG. 7A, each match in the mapping 700 may be uniquely identified within the system 100 by a match identifier comprising the phrase map/table number 700 along with the match number. Thus, for example, in the example shown in FIG. 7A, the mapping of the phrase “idea” to the pictogram identified by the pair <17, 34> is match number 6 in table 700 and may be uniquely identified within the system by the <map number, match number> pair <700, 6>.

In the example in FIG. 7A the match numbers are shown sequentially. As noted, numbering need not be sequential, and this scheme is used here merely to aid in this description.

Those of ordinary skill in the art will realize and understand, upon reading this description, that different and/or other ways of uniquely identifying each match may be used. It should be appreciated that match numbers within a table should not change if the table is updated. Accordingly, the match numbers may not necessarily correspond to row numbers in the table.

Using a unique match numbering scheme (e.g., as described above), with reference to FIG. 4D, a text message may comprises a sequence of characters or glyphs C1, C2, C3 . . . Ck, where each character comprises a glyph/pictogram identifier and a match identifier, if appropriate (i.e., if the particular glyph or character was inserted in the message as the result of a substitution). Those of ordinary skill in the art will understand how to implement efficiencies in the implementation of messages to avoid wasted space. For example, a bitmap may be used to indicate which characters in a message were inserted as a result of substitution, and only those characters need have match identifiers.

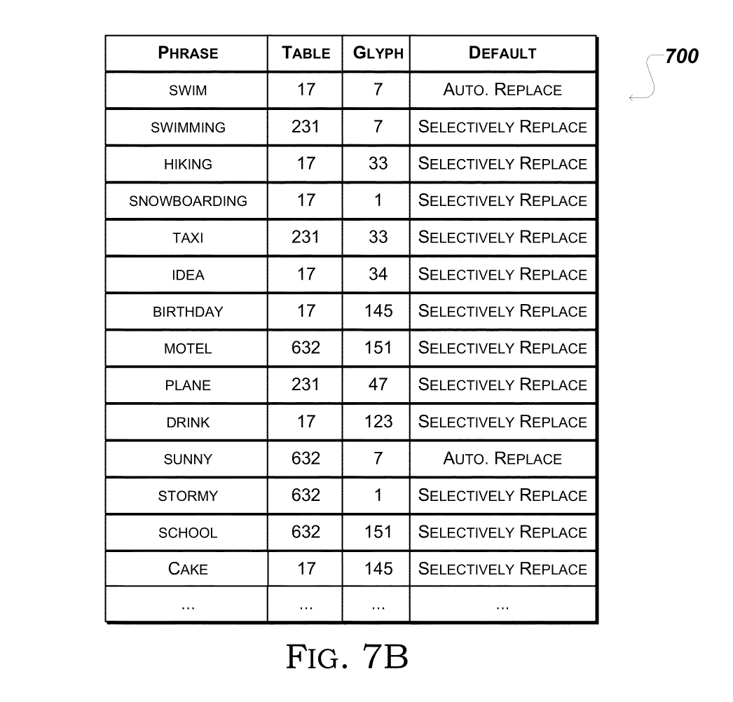

The flowchart in FIG. 9 depicts aspects of operation of the UI 236 when a user is viewing a message (which may be the current message being input or previously-input message (e.g., in a conversation)). The operations shown and described with reference to FIG. 9 may take place on the same device in which the message was input (e.g., when the user is viewing the current message being input or an older message that was already sent), or they may take place on the device of another user (e.g., a user to whom the message was sent). It is assumed that a user receiving a message will either have the required font data 244 (e.g., font table(s) 225) and phrase data 246 (e.g., phrase map(s) 247) on their device or will obtain the needed data from the backend.

With reference to FIG. 9, the UI 236 determines (at S901) whether a user viewing a message has selected a pictogram in the displayed message. The user may select a pictogram in any known manner, e.g., by tapping or clicking on it. When the UI 236 determines (at S901) that the user selected a pictogram, the UI performs a reverse lookup of the phrase map to find the phrase(s) corresponding to the selected pictogram (at S902, FIG. 9B).

Assuming that each entry in the message stream that corresponds to a phrase substitution has a corresponding unique match identifier, as described above. This match identifier may be used to determine which phrase table and which match in the phrase table were used to make a substitution. Using the match identifier scheme described above (comprising the phrase map/table number and a match number) the UI may look up the match in the appropriate phrase table to obtain or determine the phrase corresponding to the selected pictogram.

Thus, the reverse lookup (S902) for a particular pictogram in a message comprises finding the match table referenced by the unique match identifier associated with that pictogram in the message.

In presently preferred embodiments, the UI's behavior at this point depends on whether or not it is in an input mode. If the UI is in an input mode then user actions at this time may undo a previous substitution or toggle between a previously-substituted pictogram and its corresponding phrase. On the other hand, if the UI is not in an input mode (e.g., the user has selected a pictogram in an old message or in a received message) then the system preferably toggles between the selected pictogram and its corresponding phrase. It should be appreciated that this approach is merely exemplary, and that some embodiments may allow replacement of pictograms in old and/or received messages. A particular system implementation may support either or both modes of operation. However, some systems may prefer to not allow messages to be changed after they have been sent.

Having looked up the phrase corresponding to the selected pictogram (at S902), the UI determines whether or not it is in an input mode (at S903). If the UI determines (at S903) that it is not in an input mode then the UI causes the selected pictogram to be temporarily replaced in the display with its matching phrase.

If the user selects the pictogram during an input phase, the UI 236 may replace the pictogram in the text with the corresponding phrase. In this way, a user may undo the previous replacement (regardless of whether that replacement was automatic or user initiated). In some implementations, the UI 236 may distinguish between user interactions in order to determine whether to undo a previous substitution or merely toggle between a pictogram and its corresponding phrase (at S904). For example, the UI 236 may determine that a quick tap by the user on a pictogram briefly displays the corresponding phrase, whereas a long tap or multiple taps on the pictogram may cause the UI 236 to undo the replacement.

In some embodiments, in the “toggle” mode (at S904) the UI 236 may present the mapping (i.e., the phrase corresponding to a selected pictogram) on the display at the same time as the pictogram (e.g., above or below the pictogram).

Accordingly, when the UI determines (at S903) that it is in an input mode, then the UI may further determine (at S905) whether the user wishes to undo a replacement or merely toggle between a displayed pictogram and its corresponding phrase(s). If the UI determines (at S905) that the user wants to undo a previous replacement, the UI replaces the selected pictogram in the input text with its corresponding phrase (at S906). On the other hand, if the UI determines (at S905) that the user did not intend undo a previous replacement, then the UI assumes that the user wants to toggle between the display pictogram and its corresponding phrase(s) (at S904).

A particular implementation may choose to enforce a policy whereby only one phrase may map to a particular pictogram in order to avoid a one-to-many reverse mapping via the phrase table.

### Examples

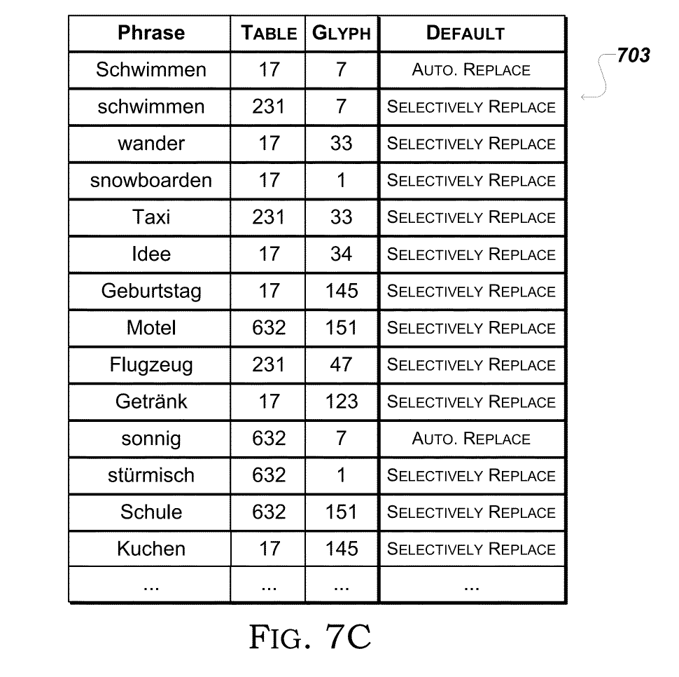

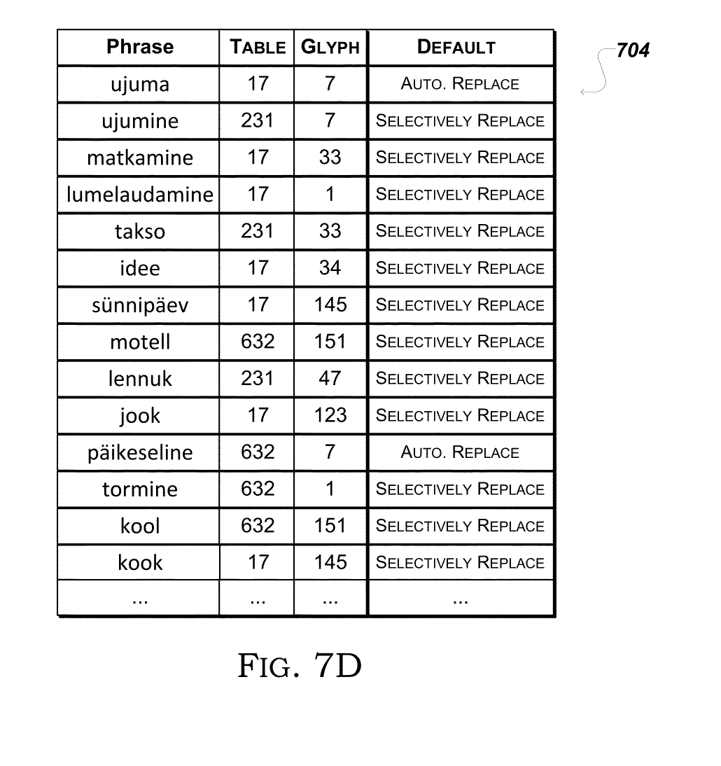

FIGS. 10A-10E, 11A-11D, 12A-12H, and 13A-13D depict examples of the system in operation, using the exemplary font tables of FIGS. 5A-5D and the example phrase table 700 of FIGS. 7A-7B.

With reference to FIGS. 10A-10E, a user uses the UI 236 of a device 104 to input text into an input region (corresponding, e.g., to the input regions shown in FIGS. 3A-3F). In these examples the user may be inputting text via a keyboard (e.g., physical keyboard or a virtual keyboard—VKB), selecting the desired characters for input.

As shown in FIG. 10A, the user has input the text “If its sunny” (shown to the left of the cursor). Assuming the alphanumeric characters use font table #1 (FIG. 5A), at this point the input buffer (FIG. 4C) contains the following sequence of identifiers: [<1,35>, <1,6>, <1,0>, <1,9>, <1,20>, <1,19>, <1,0>, <1,19>, <1,21>, <1,14>, <1,14>, <1,25>].

The phrase “sunny” matches an entry in the phrase table (FIG. 7) and maps to pictogram <632, 7>. With reference again to the flowchart in FIG. 8A, at this point the “match string” contains the phrase “sunny” and matches a string in the phrase table (at S805).

Accordingly, as shown in FIG. 10B, the UI 236 presents the matching pictogram (an image of the sun) to the user (in this example, the matching pictogram is presented on the right of the cursor. (This corresponds to S806 in the flowchart in FIG. 8A).

If the user selects the displayed pictogram (S807 in FIG. 8A), or if the default behavior for this match is automatic substitution, then, as shown in FIG. 10C, the matching phrase (“sunny”) is replaced with the corresponding matching pictogram. At this point, having replaced the string with its corresponding matching pictogram, the input buffer (FIG. 4D) contains the following:

[<1,35>, <1,6>, <1,0>, <1,9>, <1,20>, <1,19>, <1,0>, <<632, 7>, <700,11>>]

That is, the identifiers in the string corresponding to the phrase “sunny” (<1,19>, <1,21>, <1,14>, <1,14>, <1,25>) are replaced by <<632, 7>, <700,11>>, where the pair <632,7> corresponds to the matching pictogram for the phrase “sunny” in table 700, and where the pair <700,11> is the unique match identifier (for use, if needed, in reverse lookup of the pictogram).

The user may then continue to input the message (as shown in FIG. 10D.

If the user did not select the displayed pictogram (in FIG. 10B), then the input message would look like that shown in FIG. 10E.

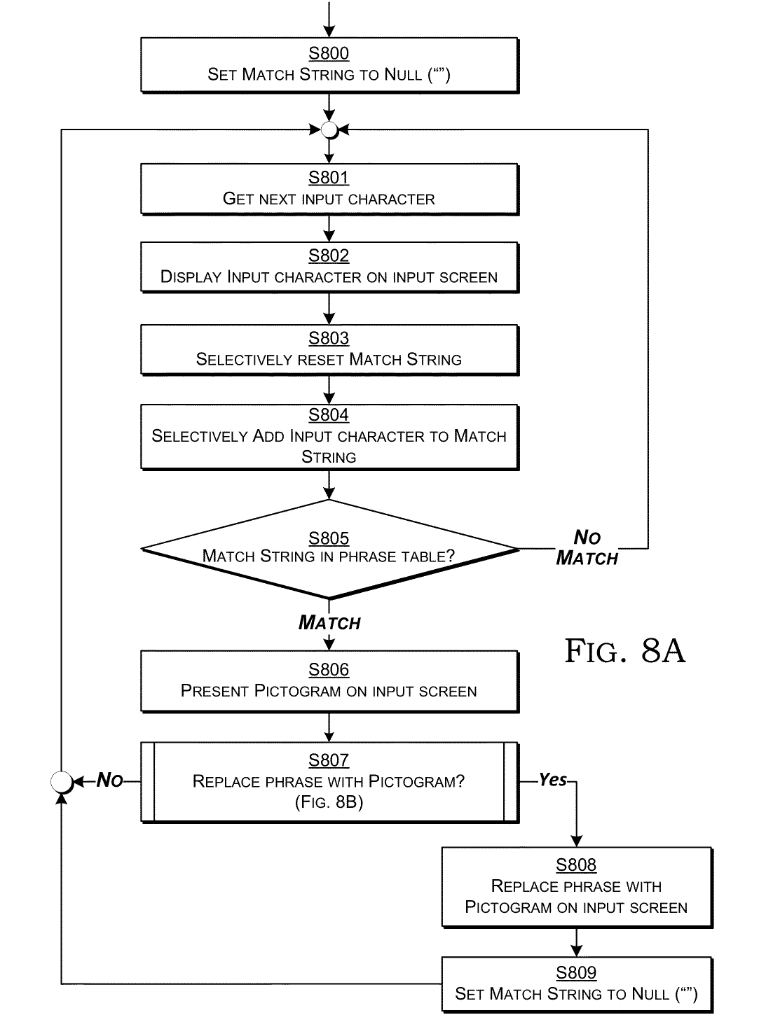

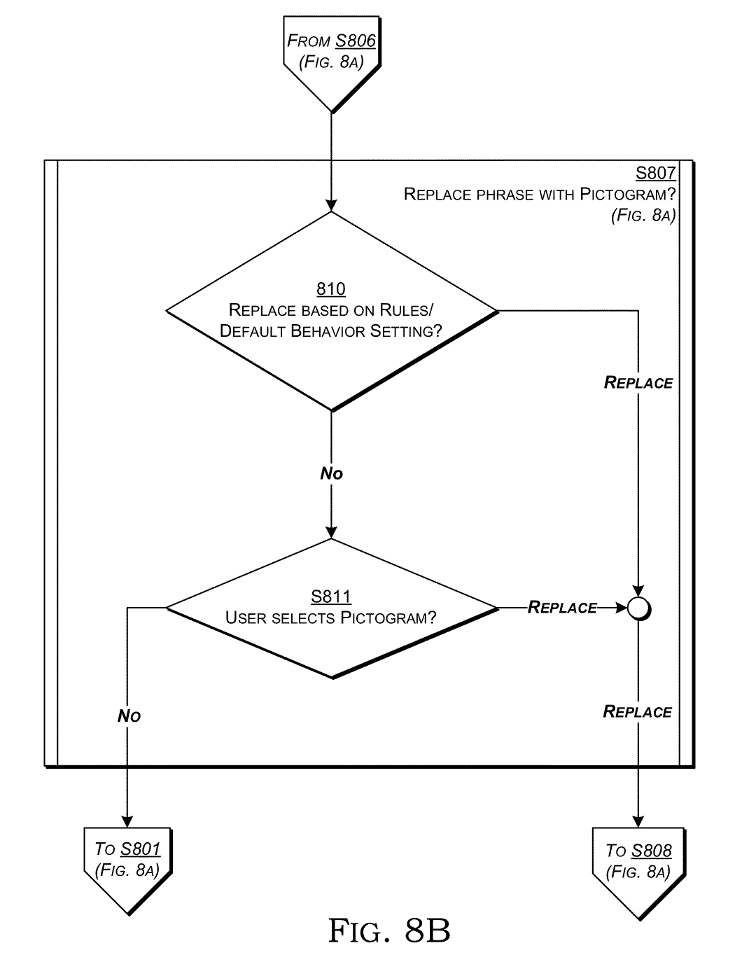

With reference to FIGS. 11A-11D, in a continuation of the above example, the user has selected to replace the phrase “sunny” with the corresponding pictogram (FIG. 11A), and continues to input text. As shown in FIG. 11C, the current match string (the string being looked up in the phrase table(s)) is “swi”. Once the user inputs the letter “m”, the match string becomes “swim” and corresponds to an entry in the phrase table (for pictogram <17, 7>). At that time the UI presents the matching pictogram to the user. In this example, the user has selected the pictogram and so the UI has replaced the phrase “swim” with the corresponding pictogram.

It should be noted that the phrase “swim” is a complete match of one phrase in the phrase table and also a partial match of another phrase (“swimming”) in the table. Preferably the UI presents a matching pictogram as soon as a first match is found.

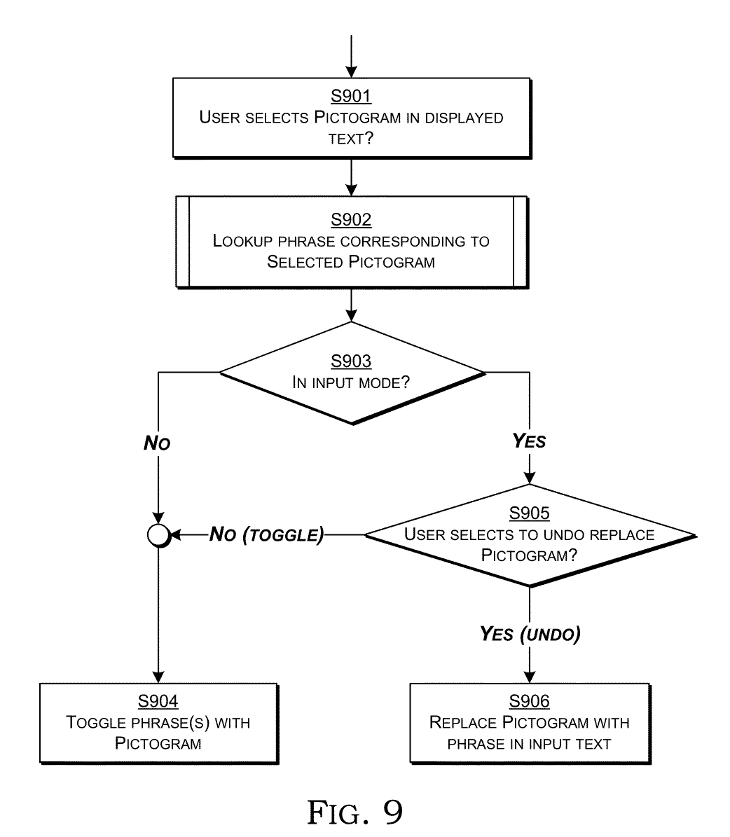

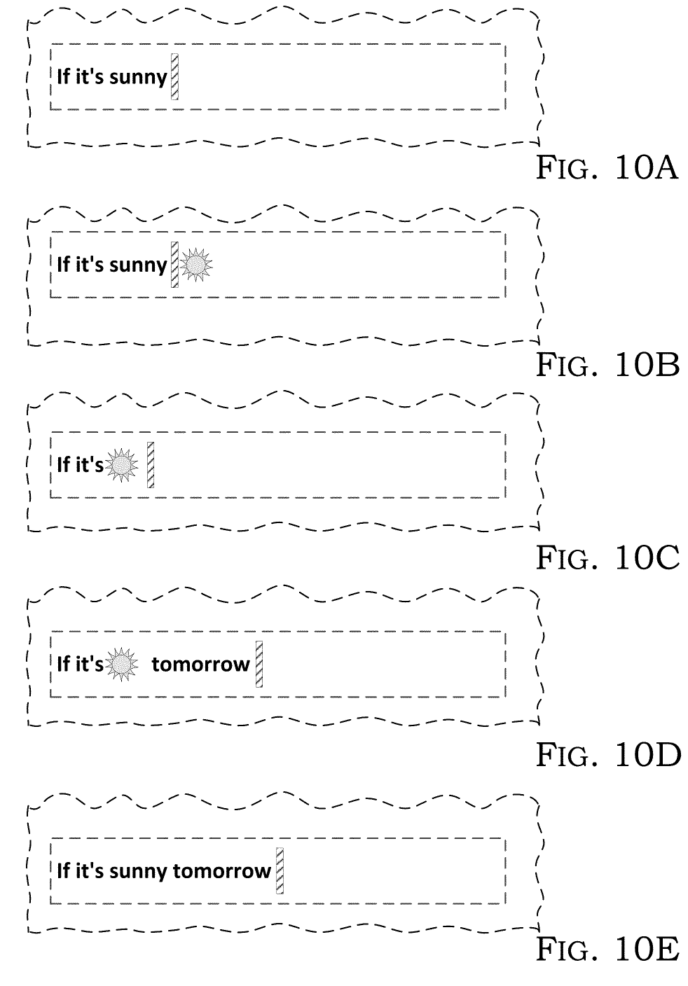

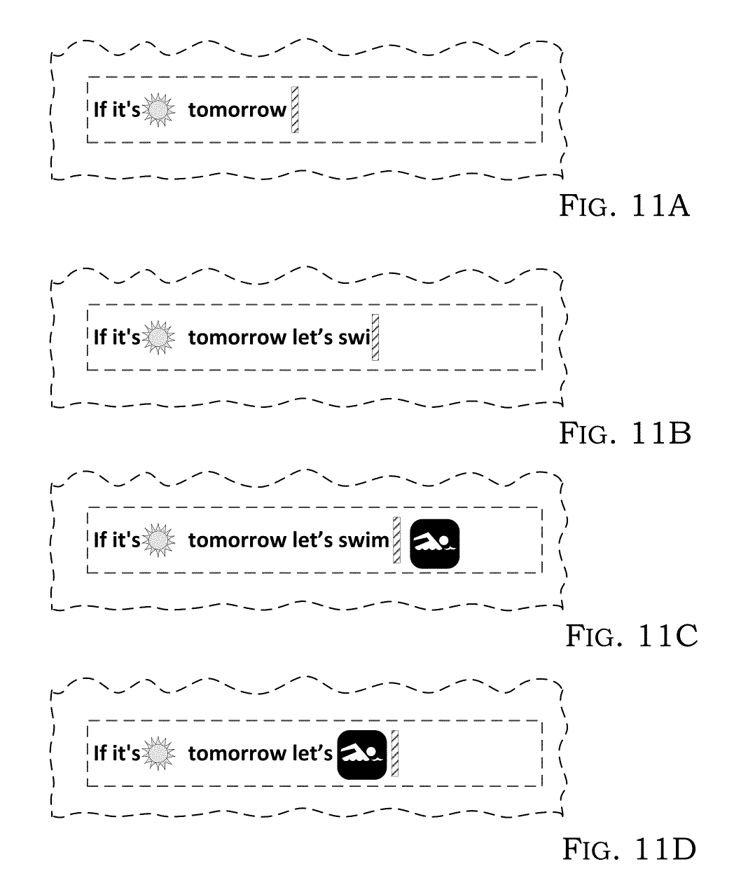

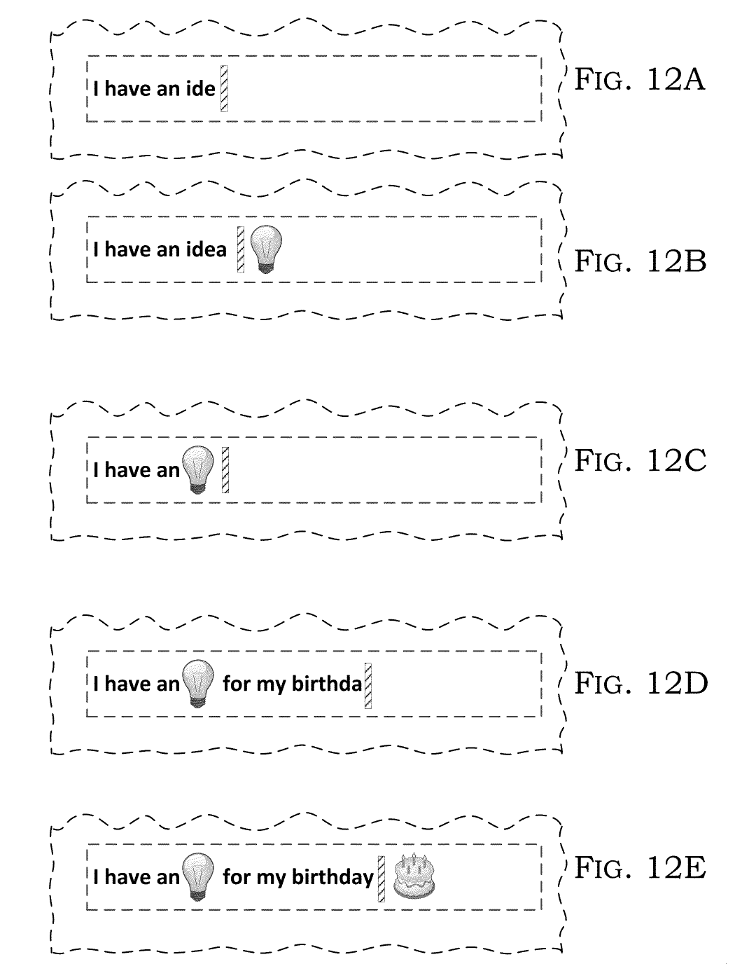

FIGS. 12A-12E present another example of the system in operation. In FIG. 12A the user has input the text “I have an ide” and the current match string is “ide”. When the user inputs the letter “a” then the match string becomes “idea” which matches an entry in the phrase table. The UI then presents the corresponding pictogram (a light bulb) to the user, as shown in FIG. 12B. In this example the user selects the pictogram and it replaces the matching text (“idea”) in the message (FIG. 12C). The user then continues to input text. As shown in FIG. 12D, the current match string is “birthda”. Once the user inputs the letter “y”, the match string becomes “birthday” which matches an entry (match number 7) in the phrase table 700 (for <17, 145>), and the corresponding pictogram (a cake) is presented to the user (FIG. 12E). In this example the user selects the pictogram (of the cake) and that pictogram replaces the matching text (“birthday”) in the message (FIG. 12F). In the message buffer the text for “birthday” is replaced with <<17, 145>, <700,7>>, where <17,145> identifies the pictogram by a <font number, glyph number> pair, and where the pair <700, 7> uniquely identifies the match that was used to make the substitution (phrase table number 700, match number 7).

As noted, the UI 236 may present the user with a pictogram when a partial match is achieved. For example, as shown in FIG. 12G, the match string “id” is a partial match for the phrase “idea” in the phrase table. In this case the UI may present the user with the matching pictogram before a full match is achieved. The user may select the presented pictogram (as shown in FIG. 1211) without entering the rest of the phrase (“idea”).

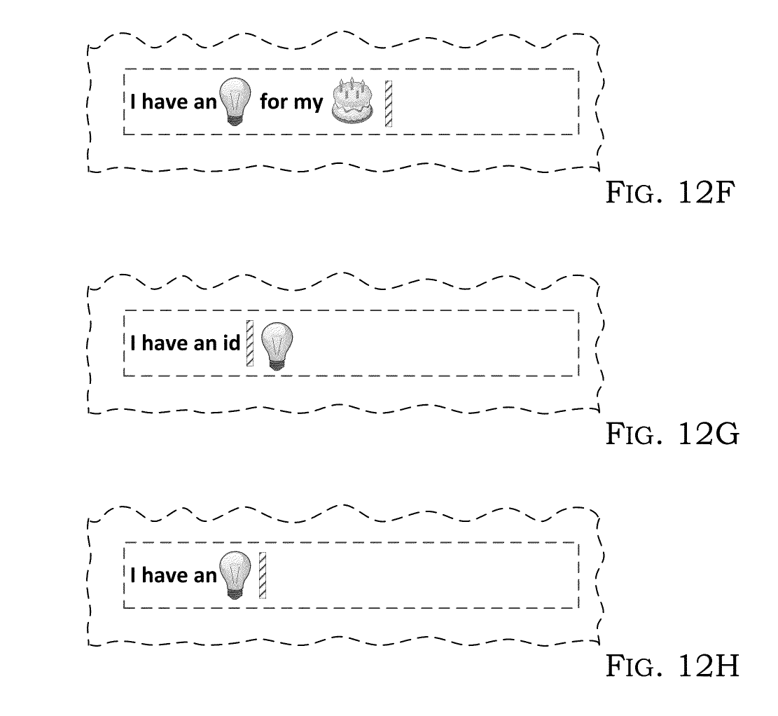

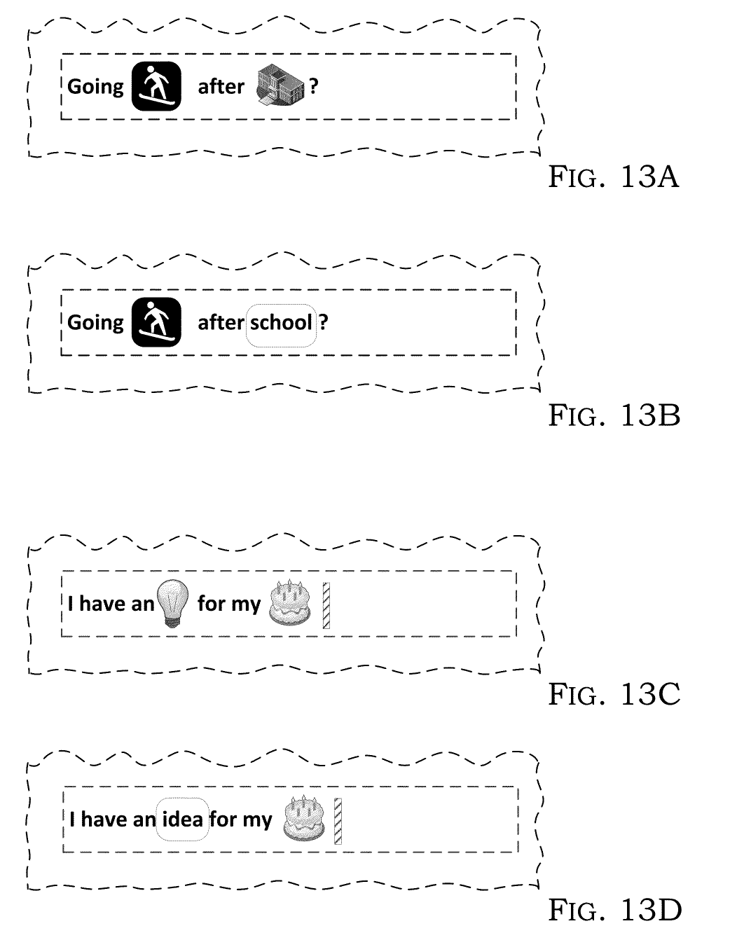

FIGS. 13A-13B show an example of a user viewing a previously-input message. The user may be viewing the message on the device on which the message was created or on another device. The user may be the creator of the message or the user may be the recipient of the message.

As shown in FIG. 13A, the message includes two pictograms. The message buffer for this message comprises the following:

[<G>, <o>, <i>, <n>, <g>, <space>, <<17,1>, <700,4>>, <a>, <, <t>, <e>, <r>, <<632,151>, <700,13>>]

For the sake of this description, characters that are not substituted are shown directly in the buffer. So, for example, the character “G” is shown as <G> as a shorthand for <1,33>, and so on. In this example the first pictogram is represented by <<17,1>, <700,4>>, where <17,1> represents glyph number one in font table 17, and where <700,4> uniquely identifies match number 4 in phrase table 700. Similarly, the second pictogram is represented by <<632,151>, <700,13>>, where <632,151> represents glyph number 151 in font table 632, and where <700,13> uniquely identifies match number 13 in phrase table 700.

When the UI determines that the user has selected one of the pictograms (S901 in FIG. 9), the UI uses the unique match identifier to determine which phrase table/match to use, and then uses the pictogram identifier (<font table, glyph number> pair) in the appropriate phrase table (S902, FIG. 9).

In this example the user has selected the pictogram denoted in the message by the pair of pairs <<632,151>, <700,13>>. The unique match identifier <700,13> identifies match number 13 of phrase table number 700 (i.e., “school”) as the corresponding phrase for pictogram <632,151>. If the device on which the reverse lookup is taking place does not already have the required phrase table (in this case table number 700) in its UI data 233 (as a phrase map 247, FIG. 2E), it may obtain that table from the backend. Preferably, and as an optimization, the backend provides each device required phrase data (from phrase data 118) in advance of it being needed by the device. Since all messages between devices pass through the backend, the backend is able to determine which UI data (e.g., which font table(s) 117 and phrase table(s) 119) may be needed by recipient devices in order to render and review received messages.

In this example, the message is an old one, for example, one that has been received by another user. The UI determines (at S903) that it is not in input mode and so the corresponding phrase will be displayed in the text (at S904). As shown in FIG. 13B, the selected pictogram corresponds to the phrase “school”, and so the user's selection of the pictogram causes the UI to display the phrase “school” in the message. The matching phrase may be displayed in some highlighted fashion (shown by the dotted lines around it in FIG. 13B) to indicate that it is a replacement for a pictogram. In preferred embodiments the user may toggle between the matching phrase and the pictogram by selecting whichever one is being displayed.

Note that if the text was in Estonian then the pictogram for the light bulb would use, e.g., phrase table 704, FIG. 7D, and the Estonian phrase “idee” would be used.

FIGS. 13C-13D show an example of a user viewing a message that is currently being input. Here the user selects pictogram of the light bulb that has already replaced the phrase “idea” in the input text. Since the UI is in input mode (at S903, FIG. 9), the UI determines (at S905) whether or not the user wants to undo the prior replacement or merely toggle between the pictogram and its corresponding phrase. The user may initially toggle (at S904) as shown in FIG. 13D, and may then choose to undo the substitution or leave it in place.

An exemplary approach to message input and presentation is thus described. Those of ordinary skill in the art will realize and appreciate, upon reading this description, that different and/or other approaches may be used within a UI, and the system is not to be limited in any way by the approach(es) described here.

Although various exemplary UIs have been described above with reference to particular devices, those of ordinary skill in the art will realize and appreciate, upon reading this description, that the UIs described may operate on any computing device, including general computing devices and special purpose computing devices.

### Computing

The services, mechanisms, operations and acts shown and described above are implemented, at least in part, by software running on one or more computers or computer systems or user devices (e.g., devices 104a, 104b, and 104c in FIGS. 2A-2C, respectively). It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

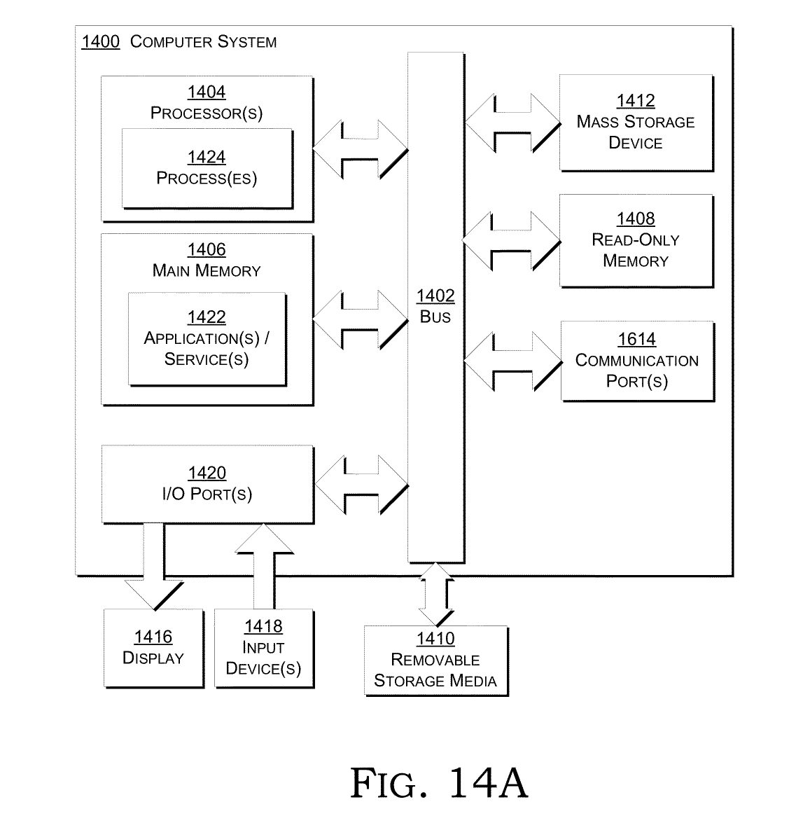

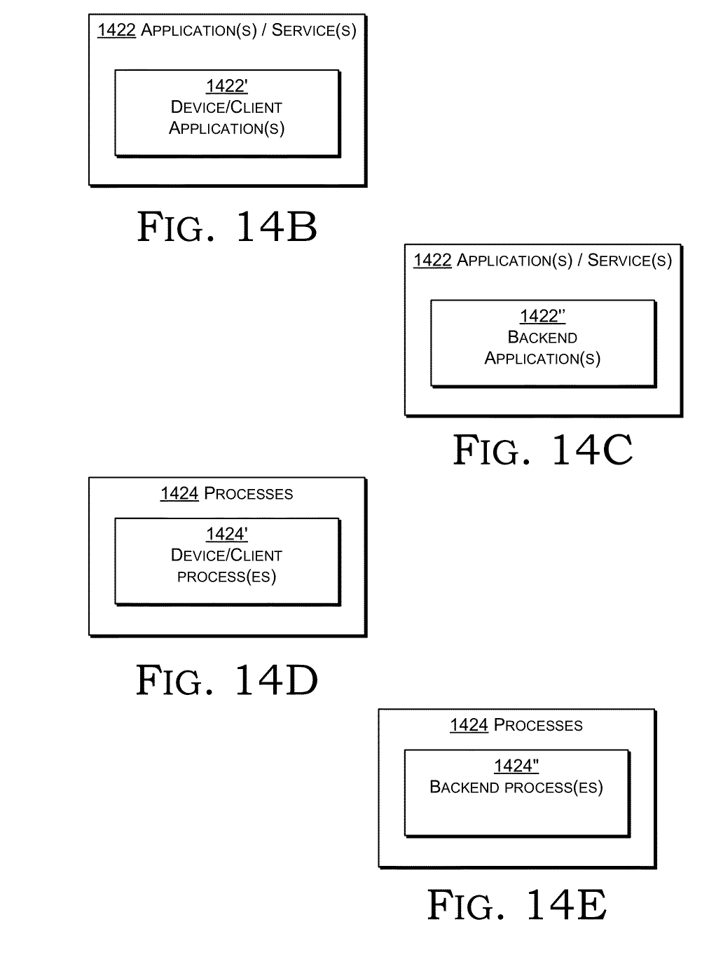

FIG. 14A is a schematic diagram of a computer system 1400 upon which embodiments of the present disclosure may be implemented and carried out.

According to the present example, the computer system 1400 includes a bus 1402 (i.e., interconnect), one or more processors 1404, one or more communications ports 1414, a main memory 1406, optional removable storage media 1410, read-only memory 1408, and a mass storage 1412. Communication port(s) 1414 may be connected to one or more networks (e.g., computer networks, cellular networks, etc.) by way of which the computer system 1400 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1404 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 1414 can be any of an RS-232 port for use with a modem based dial-up connection, a 10/100 Ethernet port, a Gigabit port using copper or fiber, or a USB port, and the like. Communications port(s) 1414 may be chosen depending on a network such as a Local Area Network (LAN), a Wide Area Network (WAN), a Content Delivery Network (CDN), or any network to which the computer system 1400 connects. The computer system 1400 may be in communication with peripheral devices (e.g., display screen 1416, input device(s) 1418) via Input/Output (I/O) port 1420. Some or all of the peripheral devices may be integrated into the computer system 1400, and the input device(s) 1418 may be integrated into the display screen 1416 (e.g., in the case of a touch screen).

Main memory 1406 can be Random Access Memory (RAM), or any other dynamic storage device(s) commonly known in the art. Read-only memory 1408 can be any static storage device(s) such as Programmable Read-Only Memory (PROM) chips for storing static information such as instructions for processor(s) 1404. Mass storage 1412 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1402 communicatively couples processor(s) 1404 with the other memory, storage and communications blocks. Bus 1402 can be a PCI/PCI-X, SCSI, a Universal Serial Bus (USB) based system bus (or other) depending on the storage devices used, and the like. Removable storage media 1410 can be any kind of external hard-drives, floppy drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 1406 is encoded with application(s) 1422 that support(s) the functionality as discussed herein (an application 1422 may be an application that provides some or all of the functionality of one or more of the mechanisms described herein). Application(s) 1422 (and/or other resources as described herein) can be embodied as software code such as data and/or logic instructions (e.g., code stored in the memory or on another computer readable medium such as a disk) that supports processing functionality according to different embodiments described herein.

For example, as shown in FIG. 14B, application(s) 1422 may include device/client application(s) 1422′ (corresponding to device/client application(s) 222 in FIG. 2D). As shown, e.g., in FIG. 2D, device/client application(s) 222 (1422′ in FIG. 14B) may include system/administrative applications 234, user interface (UI) applications 236, storage applications 238, messaging and signaling applications 240, and other miscellaneous applications 242. For example, as shown in FIG. 14C, application(s) 1422 may include backend application(s) 1422″ (corresponding to device/client application(s) 110 in FIG. 1A).

During operation of one embodiment, processor(s) 1404 accesses main memory 1406, e.g., via the use of bus 1402 in order to launch, run, execute, interpret or otherwise perform the logic instructions of the application(s) 1422. Execution of application(s) 1422 produces processing functionality of the service(s) or mechanism(s) related to the application(s). In other words, the process(es) 1424 represents one or more portions of the application(s) 1422 performing within or upon the processor(s) 1404 in the computer system 1400.

For example, as shown in FIG. 14C, process(es) 1424 may include device/client process(es) 1424′, corresponding to one or more of the device/client application(s) 1422′ (FIG. 14A). And, e.g., as shown in FIG. 14E, process(es) 1424 may include backend process(es) 1424″, corresponding to one or more of the backend application(s) 1422″ (FIG. 14B).

It should be noted that, in addition to the process(es) 1424 that carries (carry) out operations as discussed herein, other embodiments herein include the application 1422 itself (i.e., the un-executed or non-performing logic instructions and/or data). The application 1422 may be stored on a computer readable medium (e.g., a repository) such as a disk or in an optical medium. According to other embodiments, the application 1422 can also be stored in a memory type system such as in firmware, read only memory (ROM), or, as in this example, as executable code within the main memory 1406 (e.g., within Random Access Memory or RAM). For example, application 1422 may also be stored in removable storage media 1410, read-only memory 1408, and/or mass storage device 1412.

Those skilled in the art will understand that the computer system 1400 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed:

1. A computer-implemented method, implemented by hardware in combination with software, the method operable on a device for use in a multimodal communication framework, the method comprising:
(A) providing, by a graphical user interface (GUI) on said device, said GUI being implemented by said hardware in combination with said software, an input region on a screen of said device;
(B) obtaining user input in said input region;
(C) determining, using a phrase map, whether a portion of said user input matches a phrase in a set of phrases, and wherein the phrase map comprises a set of one or more phrases, and wherein each phrase in said phrase map maps to a corresponding glyph in a set of glyphs, wherein the phrase map is a global mapping within the communication framework, and wherein the set of glyphs is a global set within the communication framework;
(D) based on said determining, when said portion of said user input matches a particular phrase in said set of phrases, said particular phrase mapping to a corresponding particular glyph via said phrase map, selectively replacing said particular phrase in said input region with said corresponding particular glyph; and
(E) selectively maintaining information about a phrase replacement made in (D).

2. The method of claim 1 further comprising:
when said portion of said user input matches a particular phrase in said set of phrases, said GUI selectively presenting said corresponding particular glyph on the screen of the device as a displayed glyph.

3. The method of claim 2 wherein the input region comprises an input cursor, and wherein the GUI presents the displayed glyph on the screen.

4. The method of claim 3 wherein the displayed glyph is presented on the screen at a location selected from: (i) right of the input cursor, (ii) left of the input cursor, (iii) above the input cursor, (iv) below the input cursor, (v) above the particular phrase, and (vi) below the particular phrase.

5. The method of claim 4 wherein the location is adjacent the input cursor.

6. The method of claim 1 wherein said selectively replacing in (D) is based on a user selection.

7. The method of claim 2 wherein the selectively replacing in (D) further comprises:
(D)(2) user selection of the displayed glyph.

8. The method of claim 7 wherein said user selection of the displayed glyph comprises one or more of: (i) user tapping said displayed glyph, and (ii) user clicking on said displayed glyph.

9. The method of claim 1 wherein the selectively replacing in (D) is based on default replacement behavior information associated in the phrase map with the particular phrase and the corresponding particular glyph.

10. The method of claim 1 further comprising:
(F) when said particular phrase was replaced in the input region with said corresponding particular glyph, selectively undoing the replacement of the particular phrase.

11. The method of claim 10 wherein the selectively undoing in (F) uses the information about the replacement that was selectively maintained in (E).

12. The method of claim 1 further comprising:
(G) when said particular phrase was replaced in the input region with said corresponding particular glyph, selectively looking up the particular phrase corresponding to the particular glyph.

13. The method of claim 12 wherein the selectively looking up in (G) uses the information about the replacement that was selectively maintained in (E).

14. The method of claim 1 wherein the information about a particular phrase replacement that is selectively maintained in (E) comprises (i) an identification of the phrase map, and (ii) an identification of the mapping used in the phrase map to make the replacement.

15. The method of claim 1 wherein the selectively maintaining in (E) occurs when said particular phrase is replaced in the input region with said corresponding glyph.

16. The method of claim 10 wherein said selectively undoing in (F) comprises:
(F)(1) in response to user selection of the particular glyph in the input region, replacing the particular glyph in the input region with the particular phrase.

17. The method of claim 12 wherein the selectively looking up in (G) comprises:
(G)(1) in response to user selection of the particular glyph in the input region, displaying the particular phrase.

18. The method of claim 1 wherein said portion of said user input matches a particular phrase in said set of phrases when said portion of said user input at least partially matches said particular phrase.

19. The method of claim 1 wherein said portion of said user input matches a particular phrase in said set of phrases when said portion of said user input exactly matches said particular phrase.

20. The method of claim 1 wherein each of a plurality of users has one or more devices associated therewith, and in which said users use at least some of their devices to communicate in said multimodal communication framework via a backend system, the method further comprising:
(G) obtaining at least some of the phrase map from the backend system.

21. The method of claim 1 wherein each of a plurality of users has one or more devices associated therewith, and in which said users use at least some of their devices to communicate in said multimodal communication framework via a backend system, the method further comprising:
(H) obtaining at least some of the set of glyphs from the backend system.

22. A computer-implemented method, implemented by hardware in combination with software, the method operable on a device for use in a multimodal communication framework, the method comprising:
(A) displaying a message on a screen of said device, by a graphical user interface (GUI) on said device, said GUI being implemented by said hardware in combination with said software, wherein said message comprises a sequence of one or more glyphs;
(B) in response to a user selection of a particular glyph in said message, determining, using a phrase map, a particular phrase corresponding to said particular glyph; and
(C) presenting said particular phase using said GUI.

23. The method of claim 22 further comprising:
using information associated with said message to determine whether said particular glyph corresponds to a phrase.

24. The method of claim 23 further comprising:
using information associated with said message to identify the phrase map.

25. The method of claim 23 wherein the phrase map comprises a set of one or more phrases, and wherein each phrase in said phrase map maps to a corresponding glyph in a set of glyphs, the method further comprising:
using the information associated with the message to identify the particular phrase in the phrase map corresponding to the particular glyph.

26. The method of claim 22 wherein the message was created on the device.

27. The method of claim 22 wherein the message was received from another device.

28. The method of claim 22 wherein each of a plurality of users has one or more devices associated therewith, and in which said users use at least some of their devices to communicate in said multimodal communication framework via a backend system, the method further comprising:
(D) obtaining at least some of the phrase map from the backend system.

29. The method of claim 22 wherein each of a plurality of users has one or more devices associated therewith, and in which said users use at least some of their devices to communicate in said multimodal communication framework via a backend system,
the method further comprising:
(H) obtaining at least some of the one or more glyphs from the backend system.

30. The method of claim 29 wherein the message was received from another device, and wherein the phrase map is obtained in (D) after receipt of the message.

31. The method of claim 22 wherein the phrase map is obtained after said user selection of said particular glyph.

32. The method of claim 22 wherein the phrase map is obtained in response to said user selection of said particular glyph.

33. The method of claim 22 wherein the message was received from another device, and wherein the phrase map is obtained in (D) after receipt of the message.

34. The method of claim 22 wherein the set of glyphs comprise a set of one or more characters in one or more fonts.

35. The method of claim 22 wherein at least one of the glyphs in the set of glyphs is a non-alphabetic pictogram.

36. The method of claim 22 wherein at least one of the glyphs in the set of glyphs is an Asian-language character.

37. The method of claim 22 wherein at least one of the glyphs in the set of glyphs is an emoticon.

38. A device comprising hardware, including a processor and a memory, the device being programmed to perform the method comprising:
(A) providing, by a graphical user interface (GUI) on said device, said GUI being implemented by said hardware in combination with said software, an input region on a screen of said device;
(B) obtaining user input in said input region;
(C) determining, using a phrase map, whether a portion of said user input matches a phrase in a set of phrases, and wherein the phrase map comprises a set of one or more phrases, and wherein each phrase in said phrase map maps to a corresponding glyph in a set of glyphs, wherein the phrase map is a global mapping within the communication framework, and wherein the set of glyphs is a global set within the communication framework;
(D) based on said determining, when said portion of said user input matches a particular phrase in said set of phrases, said particular phrase mapping to a corresponding particular glyph via said phrase map, selectively replacing said particular phrase in said input region with said corresponding particular glyph; and
(E) selectively maintaining information about a phrase replacement made in (D).

39. A tangible non-transitory computer-readable storage medium comprising instructions for execution on a device, wherein the instructions, when executed, perform acts of a method for supporting a graphical user interface (GUI) on said device, wherein the method comprises:
(A) providing, by a graphical user interface (GUI) on said device, said GUI being implemented by said hardware in combination with said software, an input region on a screen of said device;
(B) obtaining user input in said input region;
(C) determining, using a phrase map, whether a portion of said user input matches a phrase in a set of phrases, and wherein the phrase map comprises a set of one or more phrases, and wherein each phrase in said phrase map maps to a corresponding glyph in a set of glyphs, wherein the phrase map is a global mapping within the communication framework, and wherein the set of glyphs is a global set within the communication framework;
(D) based on said determining, when said portion of said user input matches a particular phrase in said set of phrases, said particular phrase mapping to a corresponding particular glyph via said phrase map, selectively replacing said particular phrase in said input region with said corresponding particular glyph; and
(E) selectively maintaining information about a phrase replacement made in (D).
